(19) United States
(12) Patent Application Publication
(10) Pub. No.: US 2014/0352549 A1
(43) Pub. Date: Dec. 4, 2014

(54) Toaster Apparatus and Method

(71) Applicant: Breville Pty Limited, BOTANY NSW (AU)

(72) Inventors: Greg Upston, Ridgewood QLD (AU); Richard Hoare, LANE COVE NSW (AU); Vyvyan Rose, VAUCLUSE NSW (AU); Scott Bradly, MALABAR NSW (AU); Philip Lewis McKnight, MOSMAN NSW (AU); Ze Kang Lai, GLENFIELD NSW (AU)

(21) Appl. No.: 14/365,640

(22) PCT Filed: Dec. 17, 2012
(86) PCT No.: PCT/AU2012/001532

§ 371 Date: Jun. 16, 2014

(30) Foreign Application Priority Data
Dec. 16, 2011 (AU) 2011905256
Sep. 18, 2012 (AU) 2012904053

(51) Int. Cl. A47J 37/08

(52) U.S. Cl. CPC A47J 37/0814
USPC 99/334; 99/386; 99/342

(57) ABSTRACT

An automatic toaster apparatus comprising: a body having one or more toasting slots leading to a respective toasting cavity; one or more internal carriage for carrying bread, a carriage being associated with each toasting slots and respective toasting cavity; a plurality of toasting elements, wherein a toasting element is located at each side of each carriage. The toaster having, a supplemental toasting function, a keep warm function, a pre-warm function. The toaster enabling separate user selection of toast colour and moisture.

### FIELD OF THE INVENTION

The invention relates to toasters and more particularly to improvements in user control over toasting functions and toaster safety.

The invention has been developed primarily for use as a bread toaster and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Any discussion of the prior art throughout the specification should in no way be considered as an admission that such prior art is widely known or forms part of the common general knowledge in the field.

For the purpose of this specification, it will be understood that a wide variety of foods may be cooked in a toaster. Such foods include breads such as wholemeal breads, bagels, pastries, conventional sliced breads as well as frozen versions of all of the aforesaid examples.

It is sometimes the case that a toasting cycle results in a toasted food that is, to the taste of the user, undercooked. In such circumstances, a user will typically leave the food in the toaster, initiate another toasting cycle and then manually interrupt that cycle in order that the food not be burnt. However, if the user forgets or becomes distracted the already toasted food will go through a second full cycle and may burn.

Toasters are known to have a reheat cycle. The purpose of a reheat cycle is to bring food that has gone cold in the toaster to a temperature approximating the temperature that is normally achieved at the end of a normal toasting cycle. The purpose of a reheat cycle is to increase the temperature of the food but not to change the shade or amounts of brownness on the surface of the food. It is also known to provide a toaster with a timer that measures the amount of time since the completion of a full toasting cycle. A subsequent toasting cycle may be shortened in accordance with that measurement to account for heat in the cavity when the cycle starts.

Bread toasters are well known. The various aspects of the present invention seek to provide greater user control over the qualities of the finished toasted product. Safety enhancements are also proposed.

### OBJECTS OF THE INVENTION

It is an object of the present invention to overcome or ameliorate at least one of the disadvantages of the prior art, or to provide a useful alternative.

It is an object of the invention in its preferred form to provide a bread toaster having improved user control over toasting functions.

It is an object of the invention in another preferred form to provide a toaster apparatus with a secondary toasting cycle.

### SUMMARY OF THE INVENTION

According to an aspect of the invention there is provided a toaster, having a body and one or more internal platforms for carrying bread.

Preferably, the platform is coupled to a handle that extends out of the body of the toaster and that can be manipulated by a user.

Preferably, the toaster can include two toasting slots. More preferably, the heating element are individually enabled or disabled.

Preferably, the toaster can include three toasting slots. More preferably, the heating element are individually enabled or disabled.

Preferably each toasting cavity is associated with a centering mechanism. More preferably, guide-wires are inclined.

According to an aspect of the invention there is provided a method of operating a toaster that allows for the input selection of an individual profile and two or more parameter values.

Preferably, the parameter values include time and/or power (or wattage).

According to an aspect of the invention there is provided a method of operating a toaster to indicate to a user when to clean a crumb tray in a toaster.

According to an aspect of the invention there is provided a method of selectively disabling a toasting cavity.

Preferably, the method includes the step of receiving feedback from each respective toast carriage, indicative of a food product being presented at that carriage. Alternatively, the method includes the step of receiving user selection for each respective toast carriage, indicative of a food product being presented at that carriage.

According to an aspect of the invention there is provided a method of activating an egg synchronizing timer delay when initiating (or before commencing) a toasting operation.

According to an aspect of the invention there is provided a user access interface for a processor device, the interface comprising: a control program adapted to perform a method as herein disclosed.

Preferably, the interface comprises one or more user inputs and a display. More preferably, the display is configured to provide visual feedback on various toasting functions. Most preferably, the display provides a list of bread types. The interface, preferably enables operational parameters of the toaster to be adjusted by a user.

Preferably, the interface enables selection and operation of a secondary toasting mode. Most preferably, timing for each of the selectable toasting modes is calculated from timing data maintained in a predetermined lookup table. Most Preferably, the timing for operating the heating elements of the toaster is calculated from timing data maintained in a predetermined lookup table and the user selected mode setting and darkness setting.

### BRIEF DESCRIPTION OF THE DRAWING FIGURES

A preferred embodiment of the invention will now be described, by way of example only, with reference to the accompanying drawings in which:

FIG. 1 is a schematic view of an embodiment bread toaster according to the invention, showing an internal platform for carrying bread;

FIG. 2 through FIG. 10 each show schematic view of the bread toaster of FIG. 1, showing an internal platform in different configurations;

FIG. 11 is a schematic view of an embodiment user interface module for a bread toaster according to the invention;

FIG. 12 is a schematic view of an embodiment user interface module for a bread toaster according to the invention;

FIG. 13 is a schematic view of an embodiment user interface module for a bread toaster according to the invention;

FIG. 14 is a schematic view of an embodiment user interface module for a bread toaster according to the invention;

FIG. 15 is a schematic view of a user interface module for a bread toaster according to the invention;

FIG. 16 is a schematic view of an embodiment user interface module for a bread toaster according to the invention;

FIG. 17 is a schematic view of an embodiment user interface module for a bread toaster according to the invention;

FIG. 18 is a graph view depicting an example relationship between toast darkness, toasting time, moisture content and heating element wattage;

FIG. 19 shows an embodiment toaster element supporting card according to the invention;

FIG. 20 is a schematic view of an embodiment user interface module for a bread toaster, and a flowchart for an embodiment method of a user interface, according to the invention;

FIG. 21 is a flowchart for an embodiment method for providing a user with a graphic indication of when to clean a crumb tray in a toaster;

FIG. 22 is a schematic view of an embodiment toaster having three toasting slots;

FIG. 23 through FIG. 25 show an embodiment toaster with a motorised reciprocating toast rack;

FIG. 26 is a schematic view of an embodiment toaster having a removable exterior top cover or case;

FIG. 27 is a schematic view of an embodiment toaster having a fume sensor;

FIG. 28 is a schematic view of an embodiment two slice toaster in which one toasting cavity (or another) can be automatically selectively disabled;

FIG. 29 is a flowchart for an embodiment method of a two slice toaster in which one toasting cavity (or another) can be manually selectively disabled;

FIG. 30 is a flowchart for an embodiment method of a two slice toaster in which one toasting cavity (or another) can be selectively disabled;

FIG. 31 through FIG. 33 show a schematic view of an embodiment three slice toaster adapted to deselect a heating element;

FIG. 31 through FIG. 33 show a schematic view of an embodiment toaster having spaced apart wire guides;

FIG. 37 and FIG. 38 show a schematic view of an embodiment toaster for toasting irregularly shaped foods;

FIG. 39 through FIG. 41 show a schematic view of an embodiment user interface of a toaster for synchronizing completion of a cooking task;

FIG. 42 is a flowchart for an embodiment method for a toaster to synchronize completion of a cooking task;

FIG. 43A is a perspective view of an embodiment toaster;

FIG. 43B is a perspective view of an embodiment toaster;

FIG. 44 is a schematic view of an embodiment user interface for the toaster of FIG. 43A;

FIG. 45 is a schematic view of an embodiment lookup table for a secondary toasting cycle;

FIG. 46 is a cross section of an embodiment motorised toaster;

FIG. 47 is a cross section of an embodiment motorised toaster;

FIG. 48A through FIG. 48C are schematic views of an embodiment user interface for operating (or initiating) a supplemental cycle;

FIG. 49A through FIG. 49C are schematic views of an embodiment user interface for operating a supplemental cycle;

FIG. 50 is a schematic views of an embodiment user interface for operating a supplemental cycle;

FIG. 51A through FIG. 51C are schematic views of an embodiment user interface, showing selection of a first primary cycle period by moving a slider;

FIG. 52A through FIG. 52C are schematic views of embodiment toaster apparatus, showing a keep warm feature;

FIG. 53A through FIG. 53B are schematic views of embodiment toaster apparatus, showing a high-lift feature.

### BEST MODE AND OTHER EMBODIMENTS

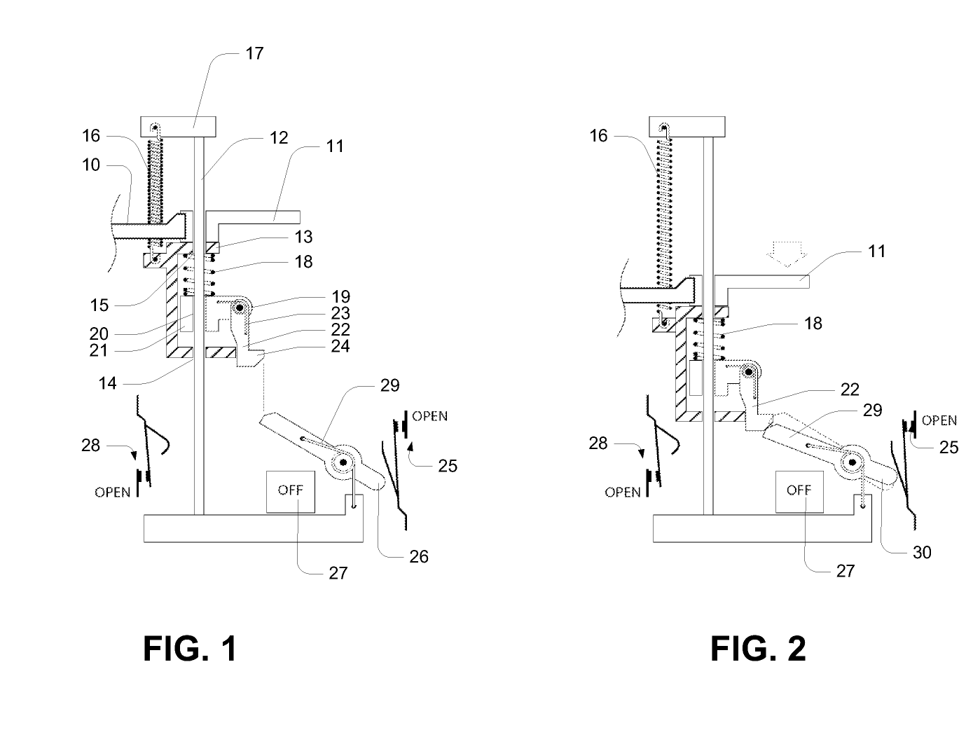

As shown in FIG. 1, a bread toaster comprises one or more internal platforms 10 for carrying bread. The platform 10 is rigidly associated with a handle 11 that extends out of the body of the toaster and that can be manipulated by a user. The platform 10 and the handle 11 that is rigidly attached to it reciprocate vertically on a post or guide 12. The platform and handle also sit atop and are separate from a reciprocating carriage assembly 13. The carriage assembly 13 has upper and lower openings 14, 15 that are adapted to receive the guide 12. The reciprocating carriage 13 is urged toward the top of the toaster by a tension spring 16. The tension spring 16 is attached to the carriage 13 and to an upper portion of the toaster's chassis 17. The carriage 13 contains within it a compression spring 18 and below the compression spring a pivoting latch assembly 19. The latch assembly 19 has a central opening 20 that receives the guide 12. The latch assembly 19 can slide vertically within the confines of the carriage 13. Its upward travel is limited by the compression spring 18. The latch assembly 19 further comprises body portion 21 having a through opening, a pivoting latch 22 and a return spring 23 extending between the body 21 and the latch 22. The return spring 23 urges the latch 22 away from the guide 12. A lower surface 24 of the latch is chamfered. The latch 22 and its chamfered undersurface 24 cooperate with the electrical switch or contacts 25 associated with the toaster's heating element circuit. This cooperation is intermediated by a spring loaded contact arm 26. The contact arm 26 is also associated with an electromagnet 27. A spring or other bias 29 urges the contact arm away from the electromagnet 27.

In the illustration of FIG. 1, the toast rack 10 and carriage assembly 13 are shown in an uppermost position. Because the heating element contact or switch 25 is illustrated as being open, no power is supplied to the heating elements. A second contact or switch 28 is used to indicate when the carriage is in a lowermost or captured position. As illustrated, these contacts 28 are also open. Thus, the toaster's microprocesser will not register that the carriage is in a lowermost position. In this orientation, the toaster is ready to receive bread or other products for toasting.

A toasting cycle is initiated in accordance with FIG. 2. As illustrated in FIG. 2, downward pressure on the handle 11 elongates the tension spring 16 and begins to compress the carriage's compression spring 18. This action drives the carriage downward and thus urges the latch 22 into preliminary engagement with the contact arm 29.

Once the latch 22 begins contact with the contact's arm 29, a portion or extension of a contact's arm 30 begins a motion toward the element circuit contact 25. In this orientation, the carriage circuit contact 28 is still open.

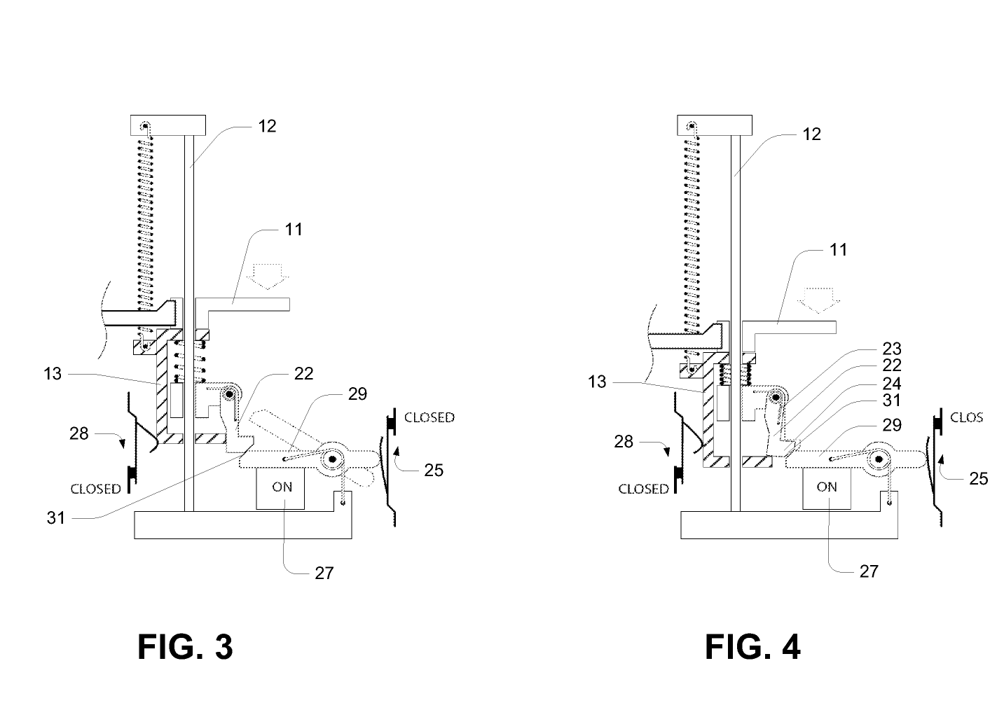

As shown in FIG. 3, further downward pressure on the handle 11 drives the latch 22 further downward. Contact between the latch and the contacts arm 29 brings the contact's arm 29 into engagement or contact with the electromagnet 27. In this orientation, the contacts arm simultaneously trips the electromagnet 27 whereupon it is retained by the electromagnet and simultaneously acts to close the element circuit contact 25. In the same orientation, a portion of the carriage assembly 13 makes contact with the carriage circuit contact 28. When both contacts 25, 28 are closed, power may be supplied to the heating coils of the toaster

As shown in FIG. 4, further downward pressure on the handle 11 causes sliding contact between the lower chamfered or tapered surface 24 of the latch 22 and the upper facing chamfered or tapered surface of the contact arm 31 as the downward motion of the carriage assembly 13 allows for it, the return spring 20 urges the latch away from the contacts arm 29 and toward the guide 12. In this example, the movement of the latch 22 toward the guide 12 is accommodated with the body of the carriage assembly 13. In this orientation, the contacts arm is maintained in its position by the electromagnet 27. Thus, regardless of the sliding motion of the latch 22, the element circuit contact 25 remains closed.

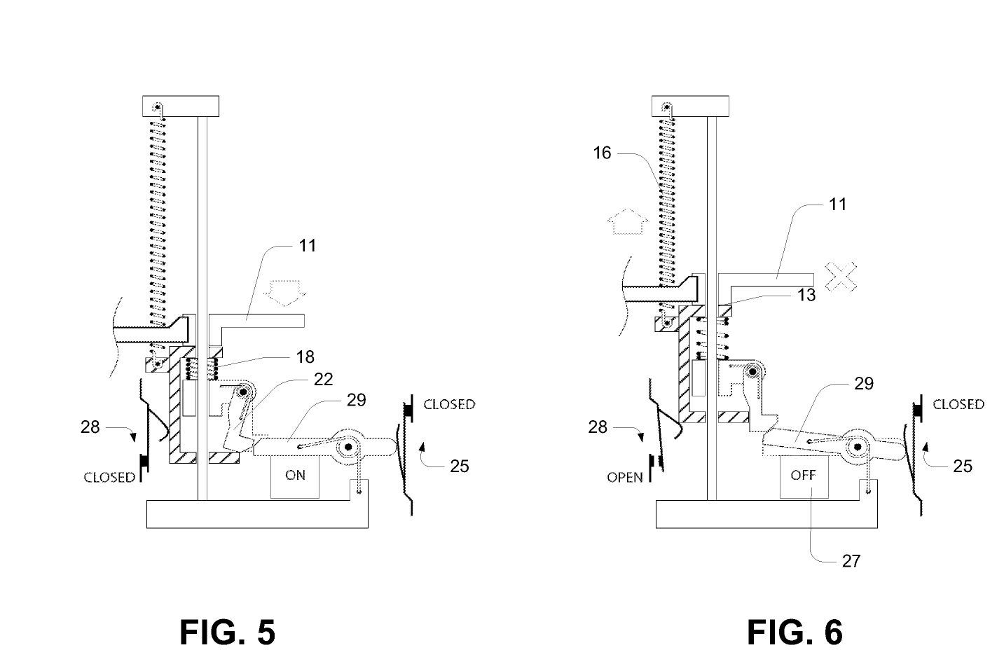

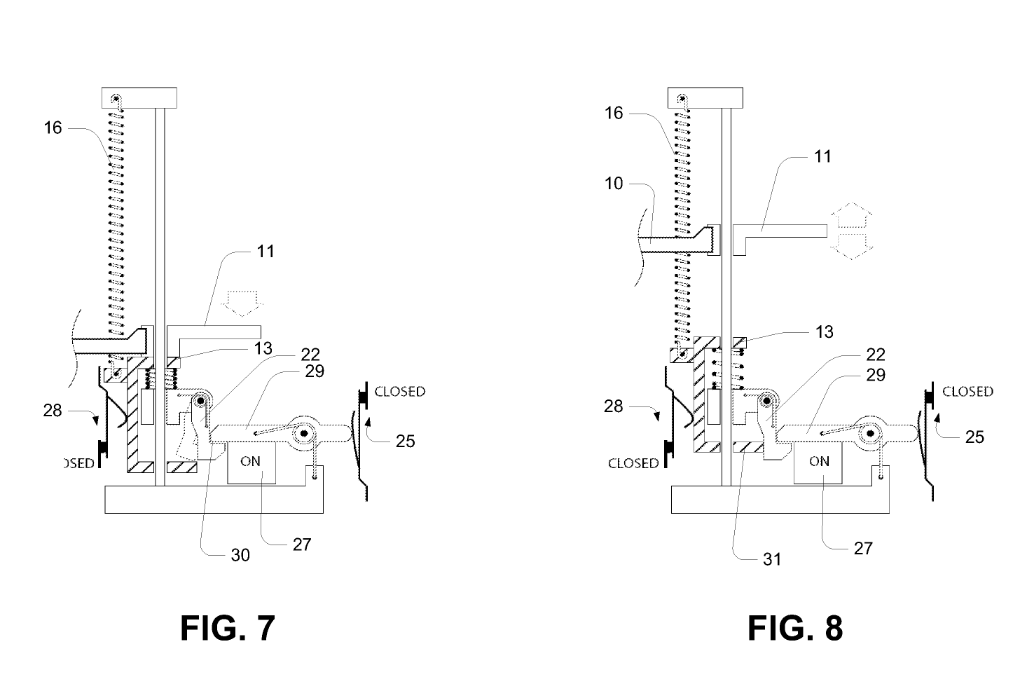

As shown in FIG. 5, further lowering of the handle 11 causes the latch 22 to retract further away from the contacts arm 29. In this orientation, the carriage assembly's compression spring 18 is further compressed and both the carriage circuit contact 28 and the element circuit contact 25 are closed. However, in this intermediate position, the carriage assembly is not restrained in its upward movement by the contacts arm 29. Thus, if downward pressure is applied to the handle 11, the carriage assembly and toast rack will rise under the influence of the tension spring 16, as shown in FIG. 6. The upward motion of the carriage assembly 13 will act to open the carriage circuit contact 28. This will act to turn off the electromagnet 27 and will thus release the contacts arm 29. Thus, the contacts arm will rotate away from the element circuit contact 25 causing power to be denied to the heating elements.

However, if with reference to the orientation depicted in FIG. 5, further pressure is applied upon the handle 11, the carriage assembly 13 will be further lowered, thus allowing the latch 22 to be temporarily cleared from then re-engaged with the contacts arm 29. As illustrated, an upper surface of the latch engages a lower surface of the contacts arm 29. This restrains the latch 29 and latch body 21 from further upward movement until the contact arm's engagement with the electromagnet 27 is interrupted. In this orientation, and as better shown in FIG. 8, the toast rack 10 and handle 11 are free to be lifted, independently of the carriage assembly 13. In this particular example, upward movement of the carriage assembly 13 is inhibited by a lower lip 30 of the carriage assembly contacting an interfering portion of the latch 22. Note that the motion of the toast rack 10 and handle 11 has no influence on either the carriage assembly 13 or the contacts 28, 25.

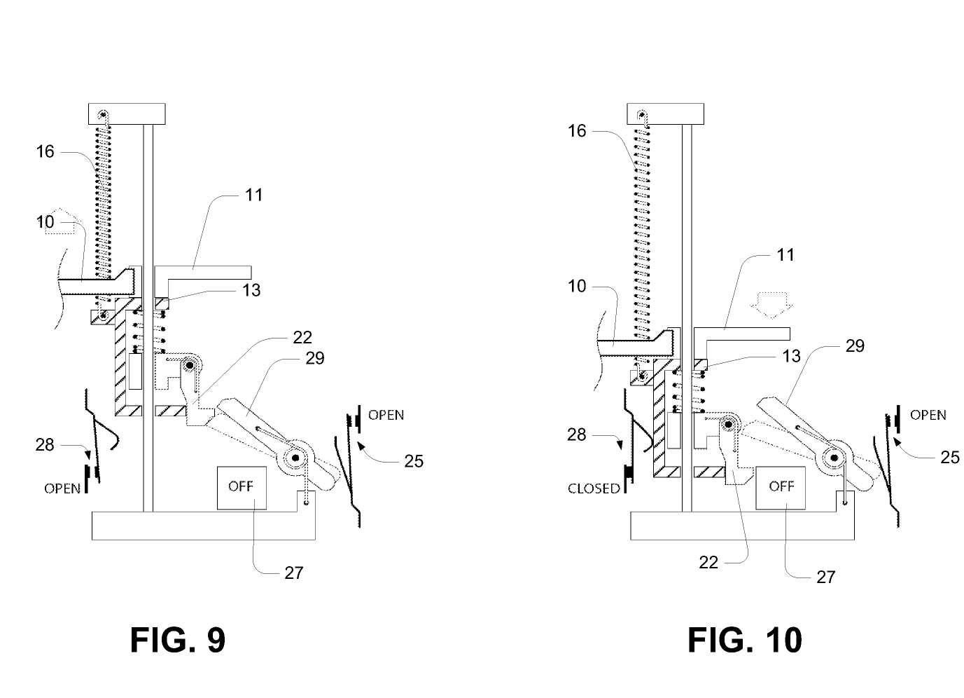

At the end of the toasting cycle and as shown in FIG. 9, the electromagnet 27 is deactivated. This allows the contact arm 29 to pivot away from the carriage assembly 13. This releases the engagement with the latch 22. Accordingly, the tension spring 16 causes the carriage assembly 13 to travel away from the base of the toaster and toward the top of the toaster. Upward movement of the carriage assembly 13 drives the toast rack 10 and handle 11 upward. The rotation of the contact arm 22 opens the element contact 25. Movement of the carriage assembly upward opens the carriage circuit contact 28.

As shown in FIG. 10, this arrangement allows de-activation of the electromagnet 27 to cause rotation of the contact arm 29 in a way that opens the heating element circuit contact 25, thus denying power to the heating elements even when downward pressure is applied to the handle 11 while the handle 11 and toast rack 10 are in their lowermost position. Thus, the operation of the heating elements and the position of the handle 11 are effectively decoupled because it is the operation of the microprocessor not the lifting of the handle that causes the deactivation or depowering of the heating elements.

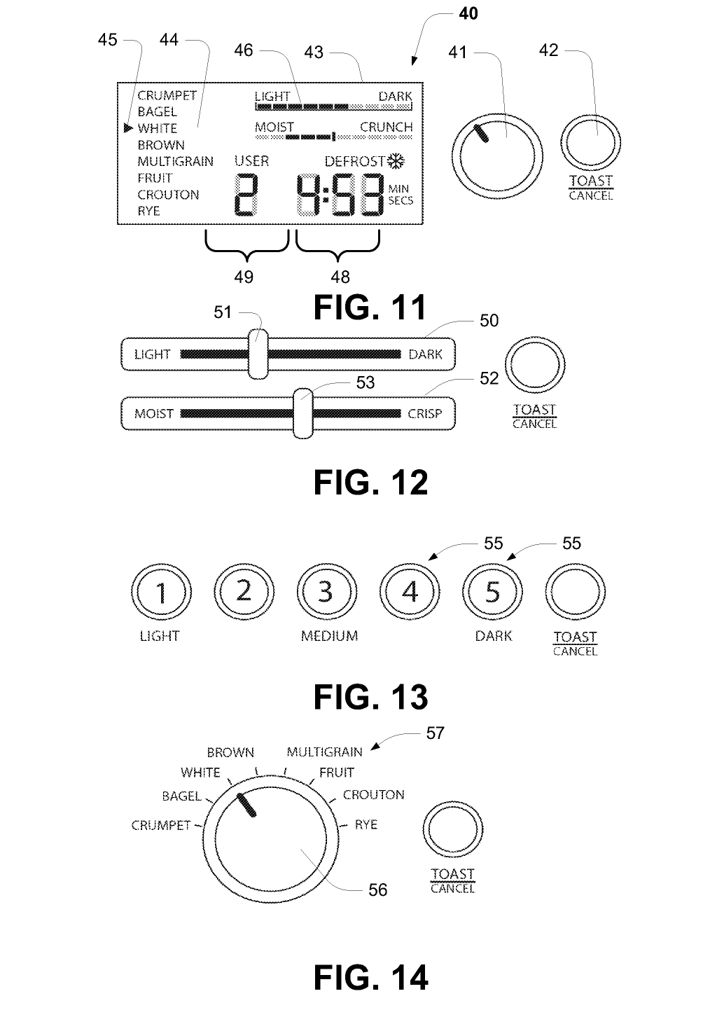

As shown in FIG. 11, a graphical interface 40 is provided for a toaster. The interface comprises one or more user inputs 41, 42 and a display 43. The display, for example an LCD display, is configured to provide visual feedback on various toasting functions. The display 43 provides a vertical list of bread types in a vertical column 44. In this example, the types can include, but is not limited to, crumpet, bagel, white, brown, multi grain, fruit, crouton and rye. An indicator 45 moves in accordance with the motion of a selector knob 41. The operational parameters of the toaster are adjusted by the toaster's microprocessor in accordance with the user selection of bread type from the column 44. As will be further explained, a toaster of this type has independent microprocessor control over toasting time and toasting wattage. The independent control over time and wattage allows for different kinds of toast quality to be used or specified. In this example, a user can independently select toast with independent properties of moisture content and toast darkness. These independently selectable parameters are displayed to the user by two separate indicators in the display 43. A first indicator 46 depicts a sliding scale having LIGHT at one end and DARK at the other end. Additional darkness is provided by extending the toasting time, however the toasting wattage also plays a role in determining toast darkness. The display 43 also provides a second indicator that provides feed back regarding a user selected moisture level. This indicator 47 is preferably located adjacent to the first indicator 46. This indicator depicts, by way of example only, a sliding scale having MOIST at one end and CRUNCH at the other end. Toast is moist when it has a higher moisture content and crunchy when it has a lower moisture content. The overall moisture content is largely determined by the toasting wattage but toasting time also plays a factor.

The graphic display 43 also contains numeric segments 48 for displaying the time remaining in a toast cycle. It may also include a numeric segment 49 for indicating a user. Because a toaster of this kind allows for the selection of various bread types, 44, each having an independent toast darkness and moisture content, the ability to discriminate between users by allowing a user to identify themselves to the toaster allows for the storing of “favourites” or preset values for each independent user of the toaster.

As shown in FIG. 12, electronic, mechanical, or electromechanical user interfaces can be provided on a toaster for independent entry of user selected toast properties. In this example, a slider 50 allows a user to select toast darkness level by the movement of a sliding tab 51. A separate input 52 allows for user control over toast wattage and therefore toast moisture content using a second sliding tab 53. The toaster's microprocessor combines the user selected values and selects the appropriate toasting time and wattage in accordance with look up tables stored in read-only memory. Similarly, and as shown in FIG. 13, a user can select darkness or moisture level values with independent switches or push buttons 55.

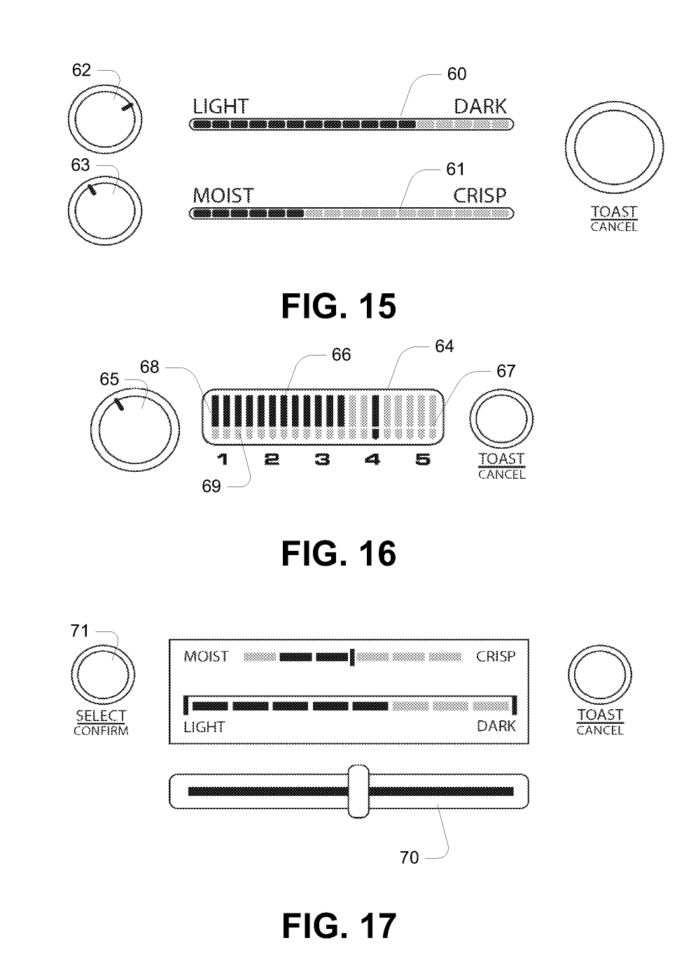

In another embodiment, various user values for toast are selected using a rotating knob 56, as shown in FIG. 14. In this example, various bread types 57 are specified by rotation if the knob 56. These bread types correspond, in order, with the bread types specified in the embodiment depicted in FIG. 11. Another method of inputting user preferences is depicted in FIG. 15. Here, independent multi-segmented, linear LED displays are used to indicate a user selected toast darkness 60 and a toast crispness or moisture content 61. To separate user inputs 62, 63 are used to adjust the two aforementioned variables and the selection is indicated on the appropriate graphic display 60, 61.

A single graphic display 64 can be toggled between serving as an indicator for toast darkness and for crispness or moisture content. In this embodiment, a single user input 65 is used to input the values for both darkness and crispness. A toggle switch alters the function of the selector 65 and the display provided 64. In an alternative embodiment, vertical segments 66 in the display area 64 are subdivided by a horizontal interruption 67. Accordingly, an upper segment 68 can be used to indicate one value and a lower segment 69 used to indicate the other value.

As shown in FIG. 17, a single slider 70 is used to input both the crispness value and the darkness value. A user operable selector switch 71 toggles the display and the variable associated with the slider 70.

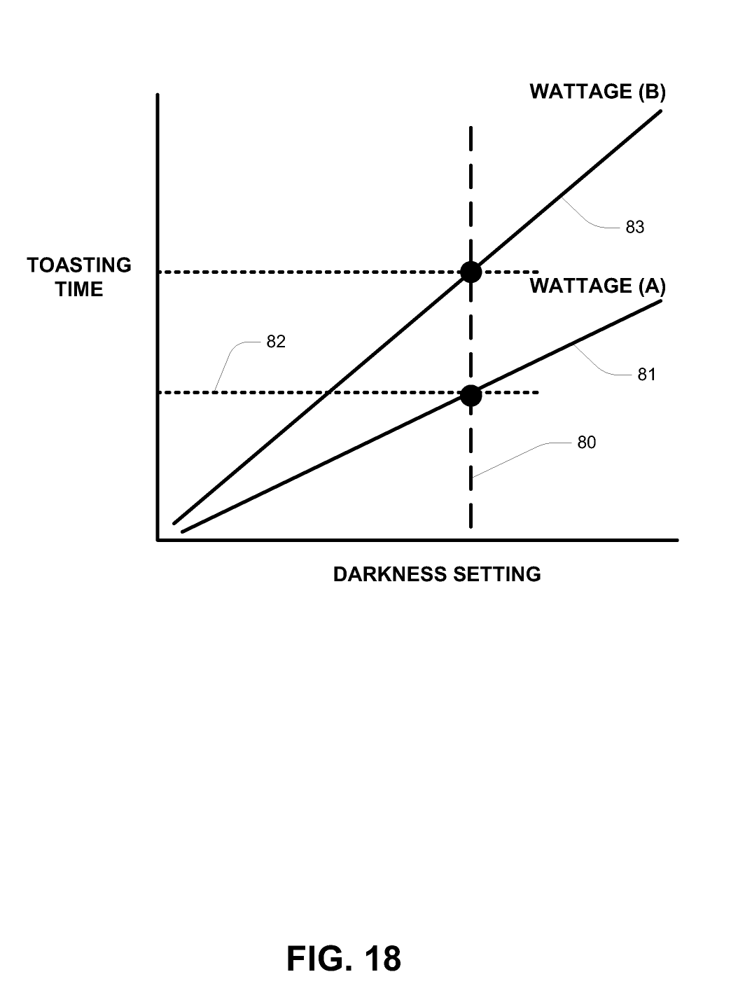

A graph depicting the relationship between toast darkness, toasting time, moisture content and heating element wattage is depicted in FIG. 18. At any given wattage, toast darkness increases with toasting time. However, wattage is inversely related to moisture content for any given toasting time. As shown in FIG. 18, for a given darkness level 80, a higher wattage 81 requires a shorter toasting time 82 then a lower wattage 83. It will be appreciated that a shorter toasting time can result in a higher moisture content. Accordingly, the processor of the toaster can store a toasting time associated with various darkness settings for each of a number of different wattages. In this way, the input of a crispness value and darkness setting can be converted to a toasting time at a given wattage by the processor. The processor will then supply the determined wattage and toasting time when a user initiates a toasting cycle.

It will be appreciated that a similar toast colouration can be achieved using different power settings, by suitably adjusting the toasting time. By adjusting the toasting time, the relative dryness (or moisture) of the resultant toast can be accordingly adjusted.

Further, a multi stage toasting cycle can also be implemented, by substantially independently establishing toast dryness and colour. For example, toast dryness can be established using a lower power setting for a longer time period, and the toast colour can be established by a higher power setting for a shorter time period. The independent phases can be cycled multiple times and in any desired order based on predetermined operating characteristics to form an optimised toasting cycle.

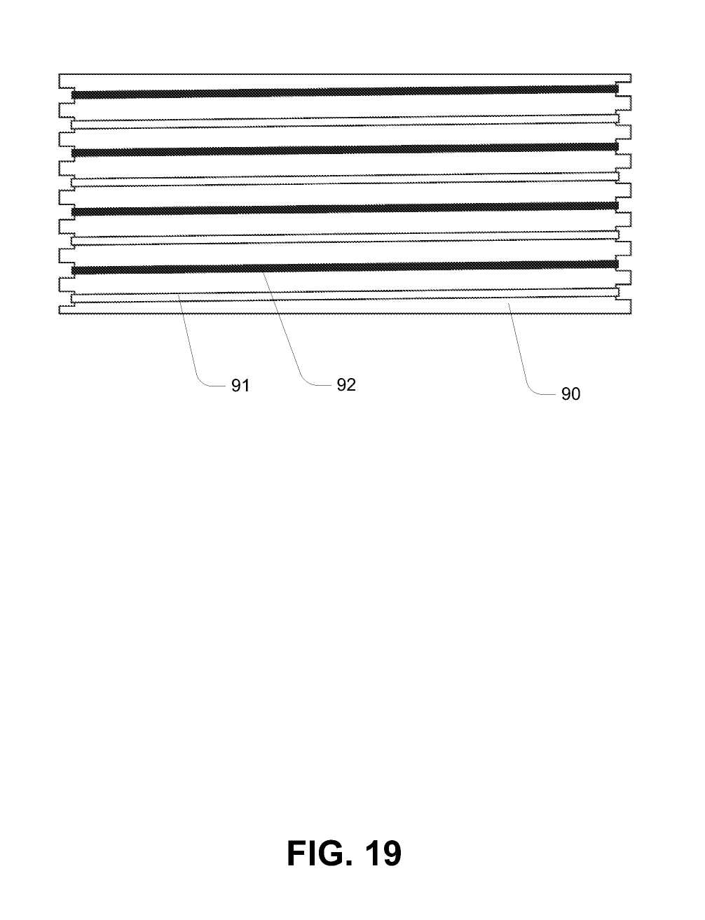

FIG. 19 depicts a toaster element supporting card 90 onto which has been wound two separate heating elements 91, 92. In this way, the wattage of the toasting elements can be varied by supplying power to either one element or both. In some embodiments, the wattage of the two elements 91, 92 is different. This provides for three different wattage levels, by using either one element, or the other, or both. This arrangement can also be utilised to contribute to the evenness of browning by alternating between one element 91 and the other 92.

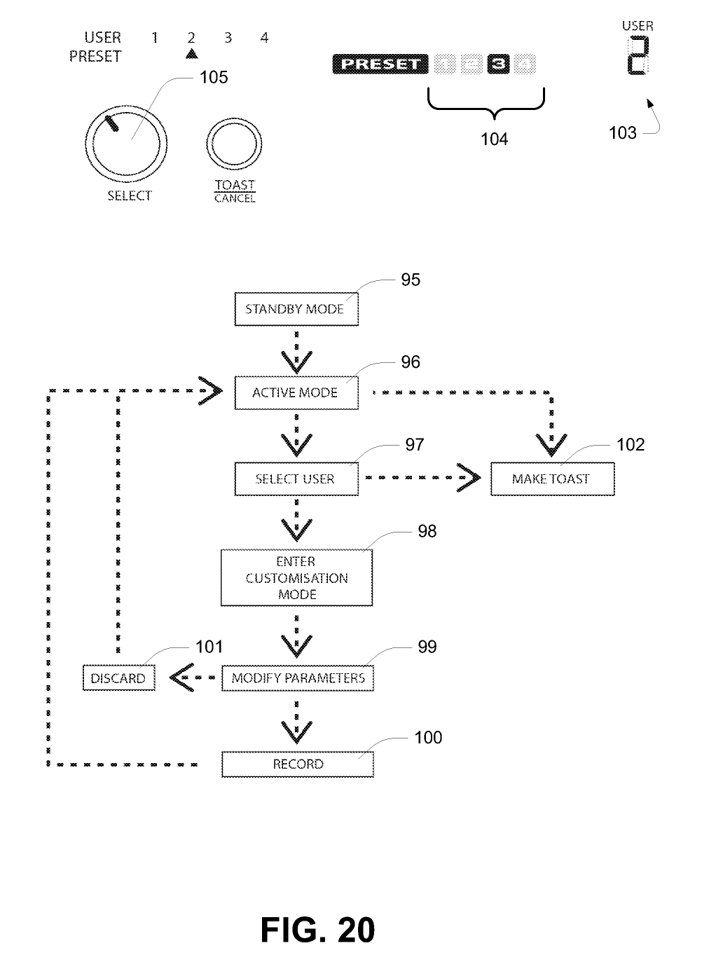

FIG. 20 schematically illustrates the operation of a toaster that allows for the input of an individual user number and two or more present values for each identified user. As illustrated, the toaster begins in a standby mode 95. The toaster enters and active mode 96, for example, by pressing any button. Thereafter, a user is selected by the input of a user number utlising any one of a variety of user inputs styles 97. A customization mode 98 is available to the user. A user can enter the customization mode either directly via a user input or by selecting two or more inputs and holding them down either simultaneously or for a selected length of time. This mode allows the user to alter the toasting parameters such as darkness and crispness. The user modifies the selected parameters 99. Optionally, an user action confirms the changes to the parameters, and the parameters are then recorded 100. In one example, the parameters are recorded if the user presses the start of toasting initiating button after parameters are modified. If a new user is selected before the parameters are recorded, the parameters are discarded 101. After parameters are either recorded 100 or discarded 101, the toaster returns to the active mode 96 and the toaster reverts to the last used user profile. Pressing of the start button will then result in the initiation of a toasting cycle 102. In the alternative, a new user can be selected 97 after the toaster reverts to the active mode 96. As further shown in FIG. 20, a toaster displays a user number or other identifier 103 and a numerically or otherwise identified list of preset values 104. One or more user inputs or selectors 105 allow a user to identify themself 103 and their selected preset 104.

FIG. 20 shows a flowchart for a method of operating a toaster that allows for the input of an individual user number and two or more present values. The method comprising the steps of:
STEP 95: a ‘Standby’ mode, which transitions to STEP 96;
STEP 96: an ‘Active’ mode, which can transition to a STEP 102 upon a users selection to start (for example pressing a start button), or which can transition to a STEP 97;
STEP 97: a ‘Select User’ mode in a predefined user can be selected, which can transition to a STEP 98;
STEP 98: a ‘Customization’ mode enables a user to alter toasting parameters (for example darkness and crispness), which can transition to a STEP 99;
STEP 99: a ‘Modify Parameters’ mode enable a user to modify the selected parameters, which can be discarded at STEP 101, but typically transitions to STEP 100;
STEP 100: a ‘Record’ mode enable a user to record or save parameters/settings, which can transition to a STEP 96;
STEP 101: a ‘Discard’ mode enable a user to transition to a STEP 96 without saving adjusted or changed parameters/settings;
STEP 102: a ‘Make Toast’ mode commences a toasting operation.

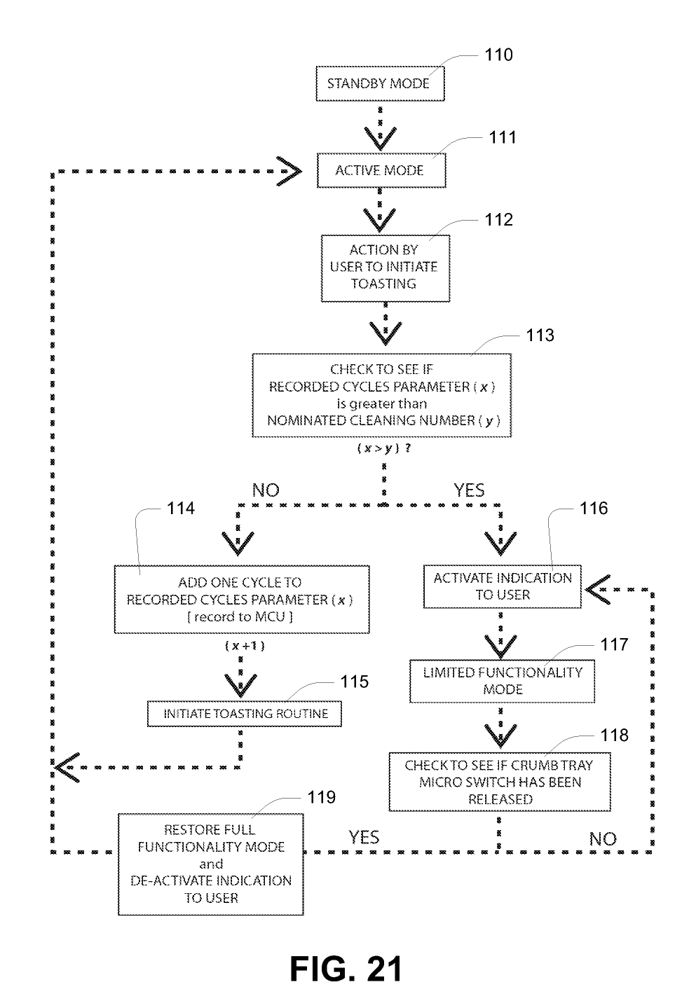

FIG. 21 illustrates a method for providing a user with a graphic indication of when to clean a crumb tray in a toaster. The toaster begins in a standby mode 110 and enters an active mode in, for example, by pressing any key on the toaster. From the active mode, a user initiates a toasting cycle 112. After the cycle is initiated, the toaster's microprocessor checks a register that holds a value that is equal to the number of toast cycles that has been completed 113 and compares this value against a nominated or preset value that represents a cleaning interval expressed in number of toasting cycles. If the number of recorded cycles is smaller than the nominated interval then one cycle is added to the recorded cycles parameter 114 and this value is stored. Thereafter the toasting routine is initiated 115 and completion of that routine returns the toaster to the active mode in. The parameter associated with the number of recorded cycles is equal to or greater than the nominated cleaning number then an indication is provided to the user 116. The indication can be graphic or auditory. Optionally, if no action is taken by the user, the toaster can be directed by the microprocessor to enter a limited functionality mode 117. This may limit the maximum wattage or duration of a toasting cycle. The crumb tray is associated with a switch (for example a micro-switch). If after the nominated cleaning number has been exceeded, the crumb tray is released and the release is detected by the microprocessor, the user indicator can be deactivated and the toaster restored to full functionality 119. If the microprocessor does not detect that the switch associated with a crumb tray has been released, then the user indication 116 persists and the optional limited functionality mode 117 may also persist.

FIG. 21 is a flow chart for a method of providing a user with a graphic indication of when to clean a crumb tray in a toaster. The method comprising the steps of:
STEP 110: a ‘Standby’ mode, which transitions to STEP 111;
STEP 111: an ‘Active’ mode, which can transition to a STEP 112 upon a users selection to start (for example pressing a start button);
STEP 112: a ‘Make Toast’ mode initiates a toasting operation, which can transition to STEP 113;
STEP 113: if a recorded cycles parameter is less than a predetermined limit transition to a STEP 114, else if a recorded cycles parameter is grater than a predetermined limit transition to a STEP 116;
STEP 114: increasing the recorded cycles parameter, which can transition to STEP 115;
STEP 115: commences a toasting operation, which can transition to STEP 111;
STEP 116: indicate clean a crumb tray to user, which can transition to STEP 117;
STEP 117: limited function mode, which can transition to STEP 117;
STEP 118: if crumb tray has been removed and replaced transition to STEP 119, else return to STEP: 116;
STEP 119: restore full function mode, which can transition to STEP in.

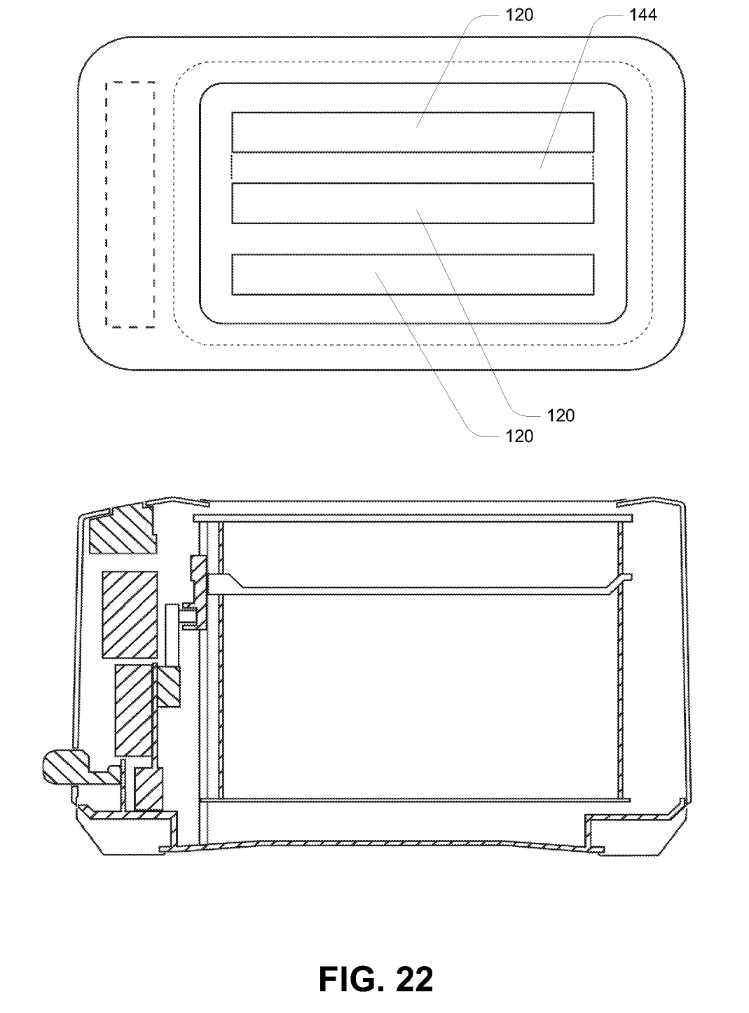

FIG. 22 illustrates a toaster with three toasting slots 120.

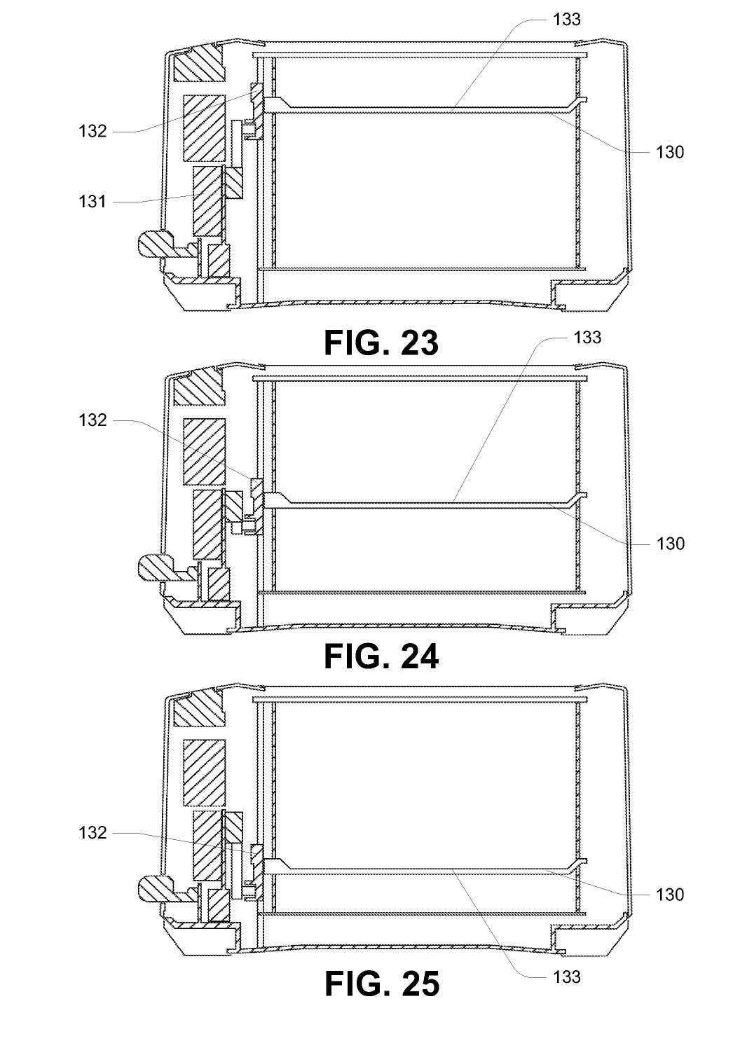

Bread and other foods that are commonly toasted vary in vertical height. Accordingly, it would be desirable to provide a toast slot with considerable depth. However, shorter objects might not protrude far enough or taller objects might protrude too far when the reciprocating toasting rack is in its upper most position. Similarly, it would be preferably to avoid the lower most area in a toasting slot unless the full height of the slot was required for a particular food. Accordingly, and as shown in FIG. 23 through FIG. 25, a toaster with a motorised, reciprocating toast rack 130 can be programmed by a user to accommodate different sized food objects. As shown in FIG. 23 through FIG. 25, a motorised actuator 131 cooperates with reciprocating carriage 132 that carries a horizontal toasting rack 133. Generally, toasting cycle begins when the rack 133 is in its lowermost position. Conventionally, this lowermost position represents the lower extremity of travel of the toasting rack. However, the motorised actuator can be instructed by the microprocessor to stop at any one of a number of intermediate levels between the uppermost and lowermost positions. The extent of the lowering, that is the distance between the top of the toaster and the rack can be selected by a user or in accordance with factory set presets. Similarly, the vertical height that the racks stops at the completion of a cycle can be matched to the user selection. Preferably, no more than half of the height of a food object is exposed at the completion of a toasting cycle.

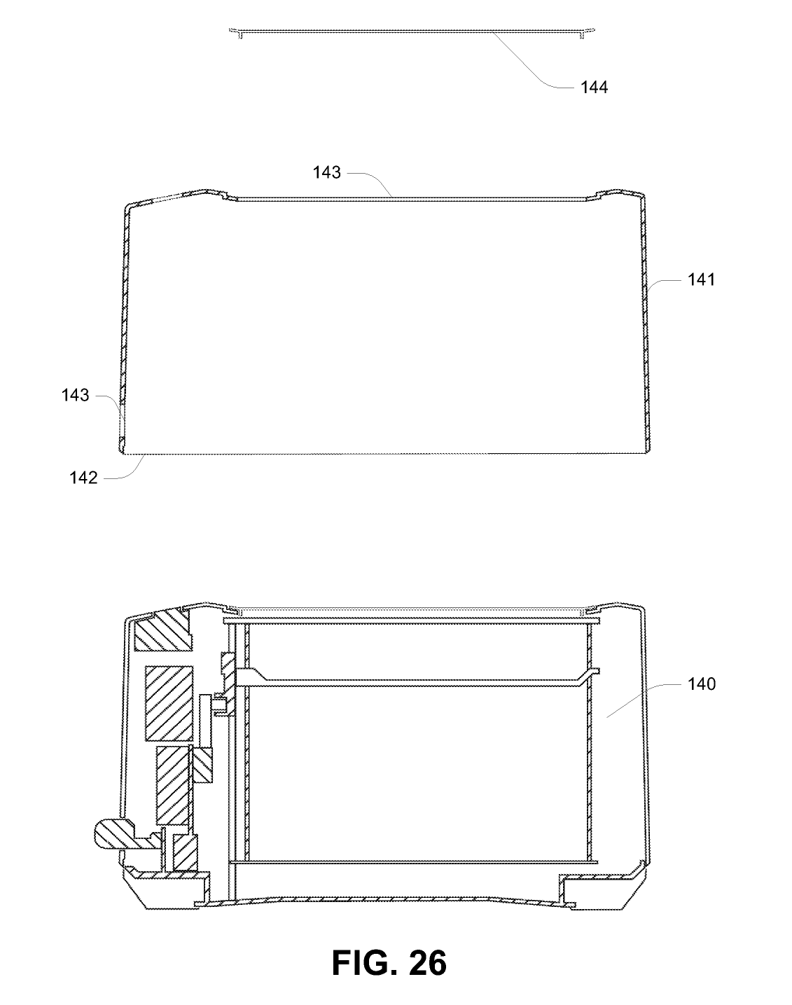

As shown in FIG. 26, a toaster 140 may be provided with a removable exterior cover or case 141. The cover or case 141 has an open bottom 142 and through openings 143, as required, to accommodate the user operated controls, electrical cord and toasting slots 143. In some embodiments, a toaster with or without a removable cover may be provided with a removable element cover 144. With reference to FIG. 22, the element cover 144 is that portion of the exterior of the toaster that separates adjacent toast slots. This area often becomes soiled more markedly than other parts of the toaster case. By allowing it to be removably retained by the toaster, the user may remove it and clean it, for example, in a dishwasher.

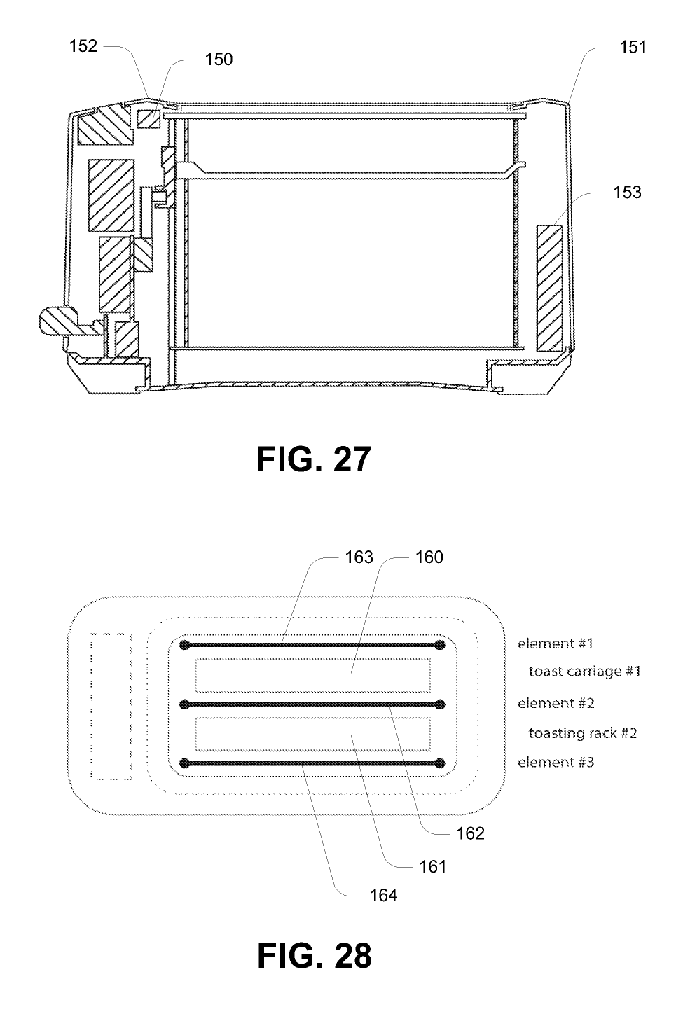

As shown in FIG. 27, the extent to which a food is toasted and optionally, whether it is over cooked, can be detected by a fume sensor 150, preferably located within an upper portion of the toaster's external covering 151. In this example, the uppermost part of the toaster forms a dome or peak 152. Because toast fumes are hotter than the surrounding air, they will tend to rise into the dome or peak 152 and thereby become more readily detectable by the sensor 150. Air circulation within the toaster can be made more uniform by locating a low speed convection fan 153 within the enclosure or cover 151. The fan 153 draws air from outside the toaster and directs it toward the toasting cavities. This air flow traverses the toasting cavities and enters that part of the enclosure that contains the sensor 150.

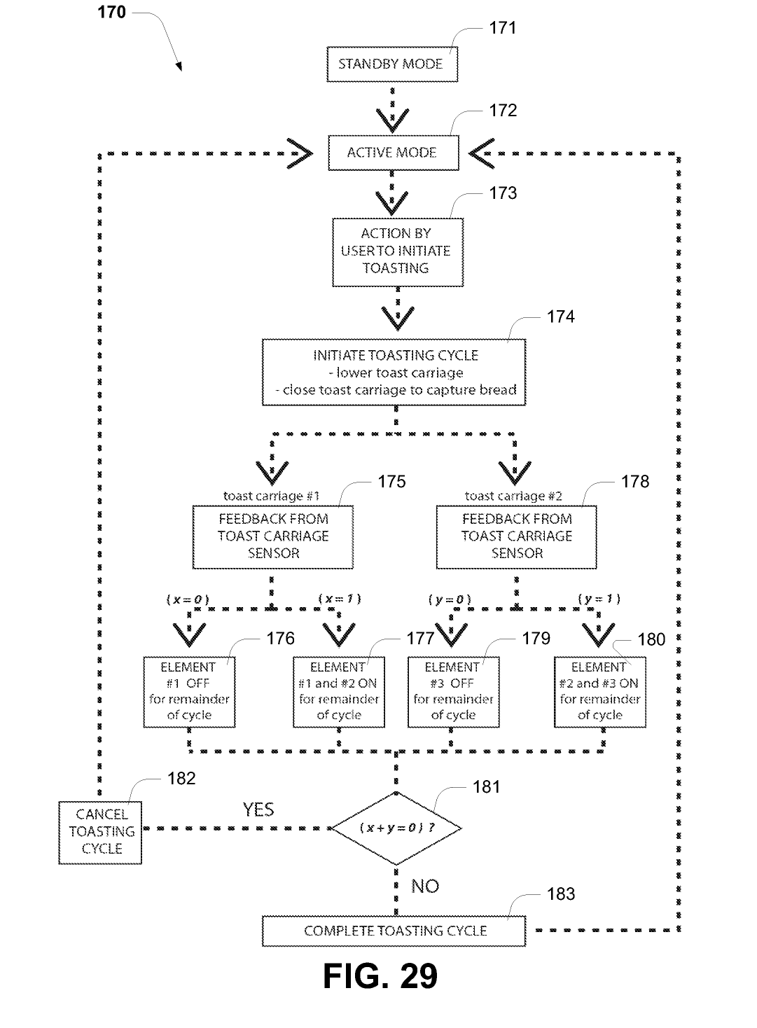

FIG. 28 and FIG. 29 illustrate a two slice toaster in which one toasting cavity (or the other) can be selectively disabled. As shown in FIG. 28, each toasting cavity 160, 161 is associated with a pair of heating elements. Both cavities 160, 161 share a common, central heating element 162. In addition, the first cavity 160 is associated with a first element 163 and the second toasting cavity 161 is associated with a second heating element 164.

The arrangement depicted in FIG. 28 allows the user to potentially deselect either the first or the second heating element 164, 164 in accordance with which toasting cavity is being used. As shown in FIG. 29, a toast sensor in a particular toasting cavity can provide information to the microprocessor that would allow the microprocessor to deselect either the first or the second heating element 163, 164 in accordance to which slot a food is located in.

FIG. 29 is a flow chart for a method 170 of selectively disabling a toasting cavity. The method comprising the steps of:
STEP 171: a ‘Standby’ mode, which transitions to STEP 172;
STEP 172: an ‘Active’ mode, which can transition to a STEP 173 upon a users selection;
STEP 173: an initiation action by the user, which can transition to a STEP 174 upon a users selection to start (for example pressing a start button);
STEP 174: a ‘Make Toast’ mode initiates a toasting operation for each of two toasting cavities, transition to respective STEP 175 and STEP 178;
STEP 175: upon feedback from a respective toast carriage A, if no food product is presented transition to STEP 176, else transition to STEP 177;
STEP 176: disable element #1, transition to STEP 181;
STEP 177: enable elements #1 and #2, transition to STEP 181;
STEP 178: upon feedback from a respective toast carriage B, if no food product is presented transition to STEP 179, else transition to STEP 180;
STEP 179: disable element #3, transition to STEP 181;
STEP 180: enable elements #2 and #3, transition to STEP 181;
STEP 181: upon feedback from both toast carriages, if no food product is presented transition to either carriages transition to STEP 182, else transition to STEP 183;
STEP 182: cancel toasting cycle, transition to STEP 172;
STEP 183: commence/complete toasting cycle, transition to STEP 172.

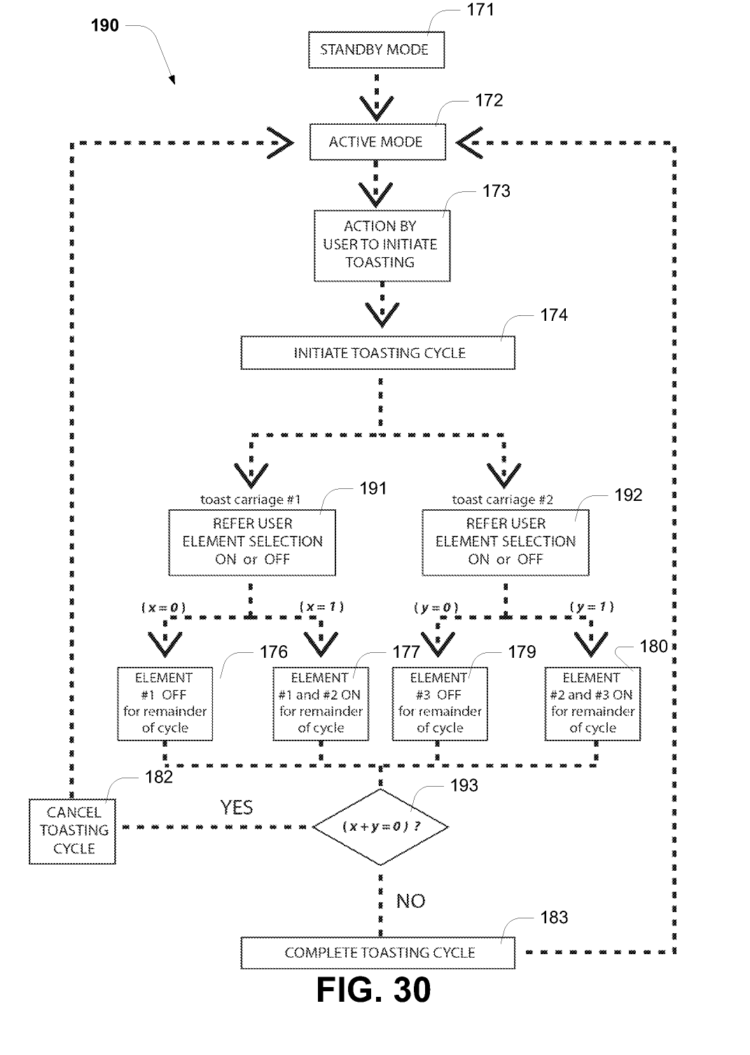

FIG. 30 illustrates a similar method 190 based on user selection rather than feed back from a toast detecting sensor. The method comprising the steps of:
STEP 171: a ‘Standby’ mode, which transitions to STEP 172;
STEP 172: an ‘Active’ mode, which can transition to a STEP 173 upon a users selection;
STEP 173: an initiation action by the user, which can transition to a STEP 174 upon a users selection to start (for example pressing a start button);
STEP 174: a ‘Make Toast’ mode initiates a toasting operation for each of two toasting cavities, transition to respective STEP 191 and STEP 178;
STEP 191: upon user selection for a respective toast carriage A, if no food product is presented transition to STEP 176, else transition to STEP 177;
STEP 176: disable element #1, transition to STEP 193
STEP 177: enable elements #1 and #2, transition to STEP 193
STEP 192: upon user selection for a respective toast carriage B, if no food product is presented transition to STEP 179, else transition to STEP 180;
STEP 179: disable element #3, transition to STEP 193;
STEP 180: enable elements #2 and #3, transition to STEP 193;
STEP 193: upon user selection for both toast carriages, if no neither carriage is selected transition to STEP 182, else transition to STEP 183;
STEP 182: cancel toasting cycle, transition to STEP 172;
STEP 183: commence/complete toasting cycle, transition to STEP 172.

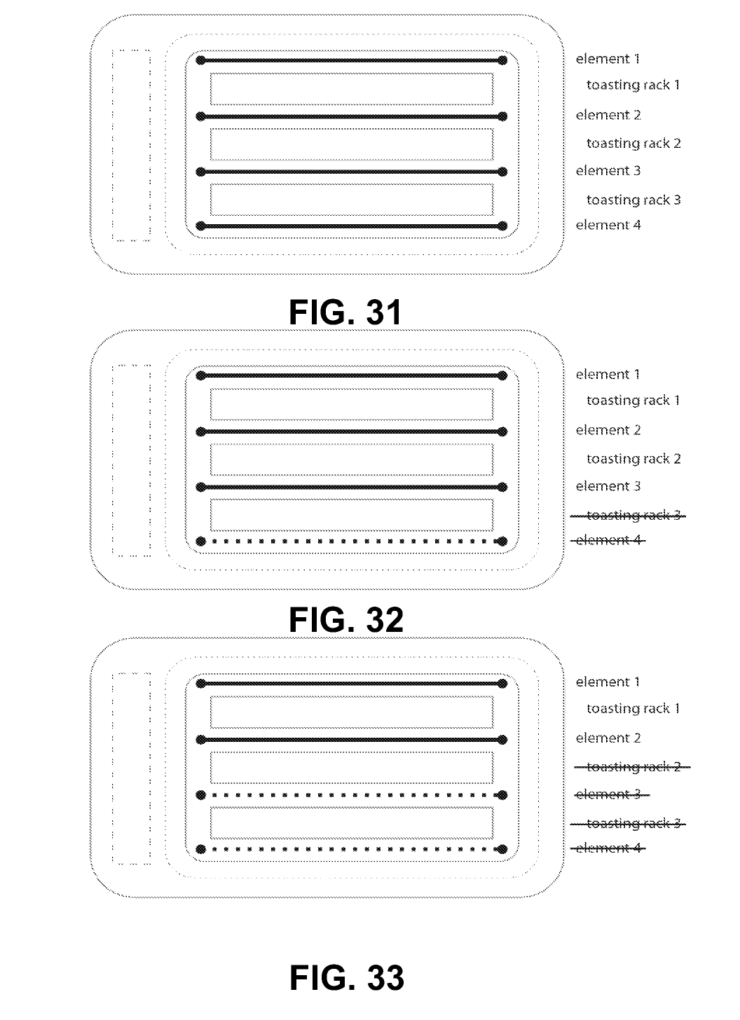

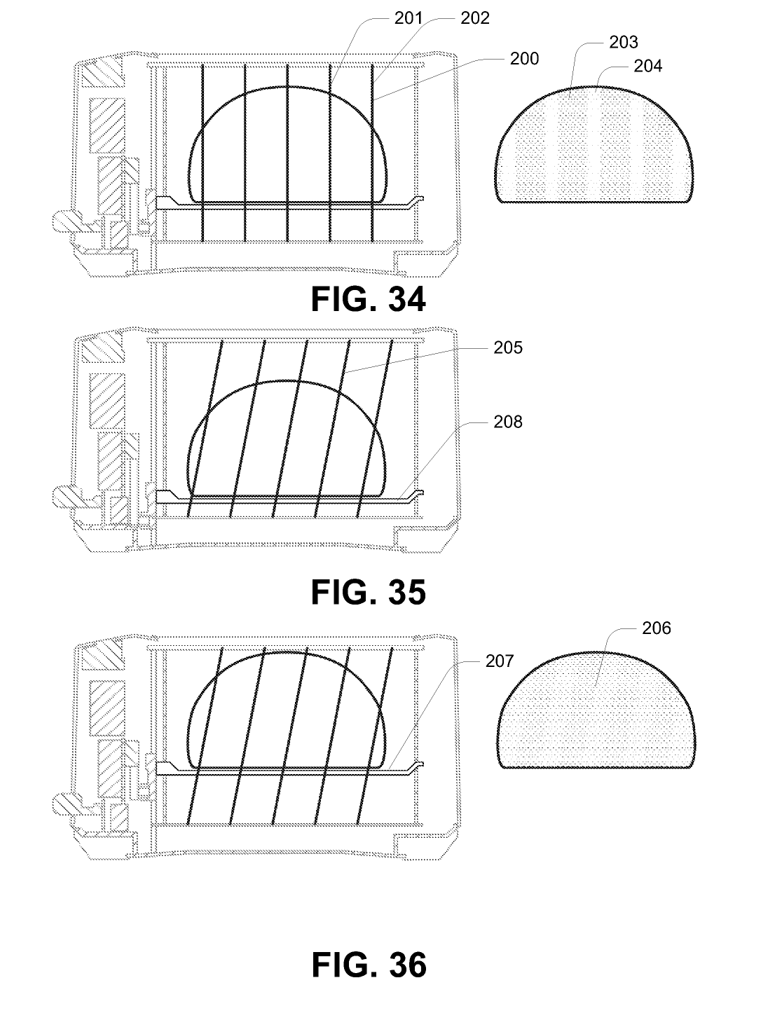

FIG. 31 through FIG. 33 illustrate how a three slice toaster may be adapted to deselect a heating element in accordance with either user selections or determinations by sensors and the toaster's microprocessor. FIG. 31 illustrates a three slice toaster in which all four elements are activated. FIG. 32 illustrates a three slice toaster in which three of the four elements are activated and the fourth element is deactivated because the third toast cavity is not being utilised. FIG. 33 schematically illustrates a three slice toaster in which only two elements are activated and only one cavity is in use. As previously suggested, the arrangement of active elements can either be accomplished by direct user selection or in conjunction with sensors that determine the presence of a food in the cavity.

As shown in FIG. 34, a toasting cavity is known to be associated with a centering mechanism 200 comprising a pair of spaced apart wire guides that come together as the toasting rack is lowered into the cavity. In conventional toasters, the centering mechanism comprises spaced apart vertical wires 201, 202. The spaced apart wires 201, 202 allow radiant energy from the heating elements to impinge on the toast but sometime create alternating bands of darkness and lightness 203, 204 on the finished toast. The light bands 204 are a result of interference from the vertical wires 201, 202. As shown in FIG. 35 and FIG. 36, this problem can be mitigated by providing inclined 205 rather than vertical guide-wires 201, 202. By providing the toast centering mechanism with inclined wires 205 and by reciprocating the toast rack between a first position 207 and a second position 208 within the toasting cavity (and with the heating elements on) radiant energy is more evenly distributed during the toasting process and the alternating bands are largely eliminated 206.

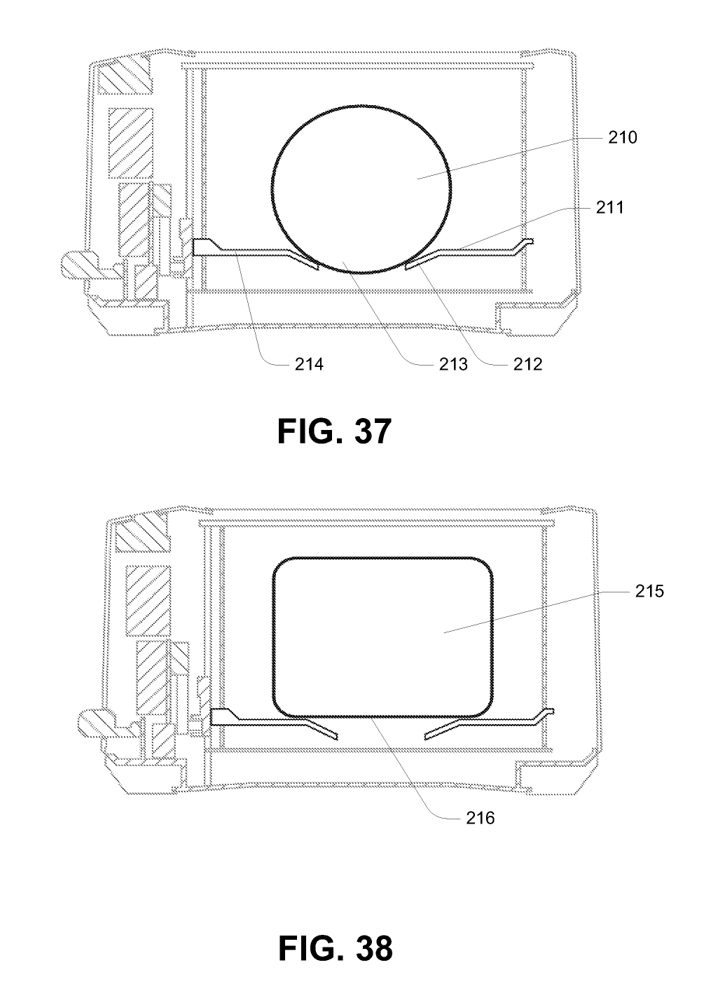

As illustrated in FIG. 37 and FIG. 38, round and other irregularly shaped foods 210 can be toasted more evenly by providing a reciprocating toast rack 211 having a central gap or depression 212 that avows a lower most portion of the food object 210 to protrude slightly below the horizontal upper surface 214 of the rack 211. In this way, and with reference to FIG. 38, a conventional bread slice 215 or other food object with a flat lower edge 216 can be supported on the horizontal surface 214, the same rack being used for a round object 210.

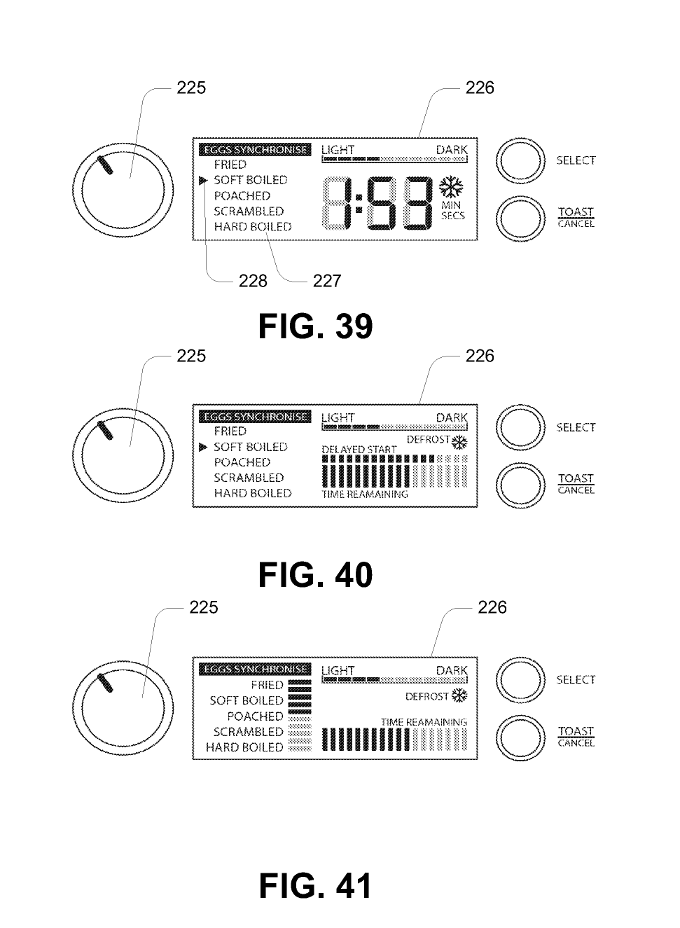

As shown in FIG. 39 through FIG. 42 a toaster may be provided with a timer that allows a user to synchronize the completion of a cooking of an egg with the completion of a toasting cycle. As shown in FIG. 39 through FIG. 41, the timer comprises one or more user inputs 225 and a graphic interface 226. FIG. 39 through FIG. 41 illustrate different styles of graphic interface. In a first style, and as shown in FIG. 39, the graphic display 226 provides a list of cooked egg styles in a vertical array 227. The rotating user input knob 225 allows the user to select a given cooked egg style. A graphic indicator 228 notifies the user of the selected style from the list 227. Each cooking style is associated in the toaster's microprocessor memory with a pre-established cooking time. As previously discussed, the user selection of parameters such as toast darkness and crispness also result in the microprocessor determining a duration of a toasting cycle. The duration of the toasting cycle will typically be less than the duration of the cooking time for the selected egg style, but can be more in some embodiments.

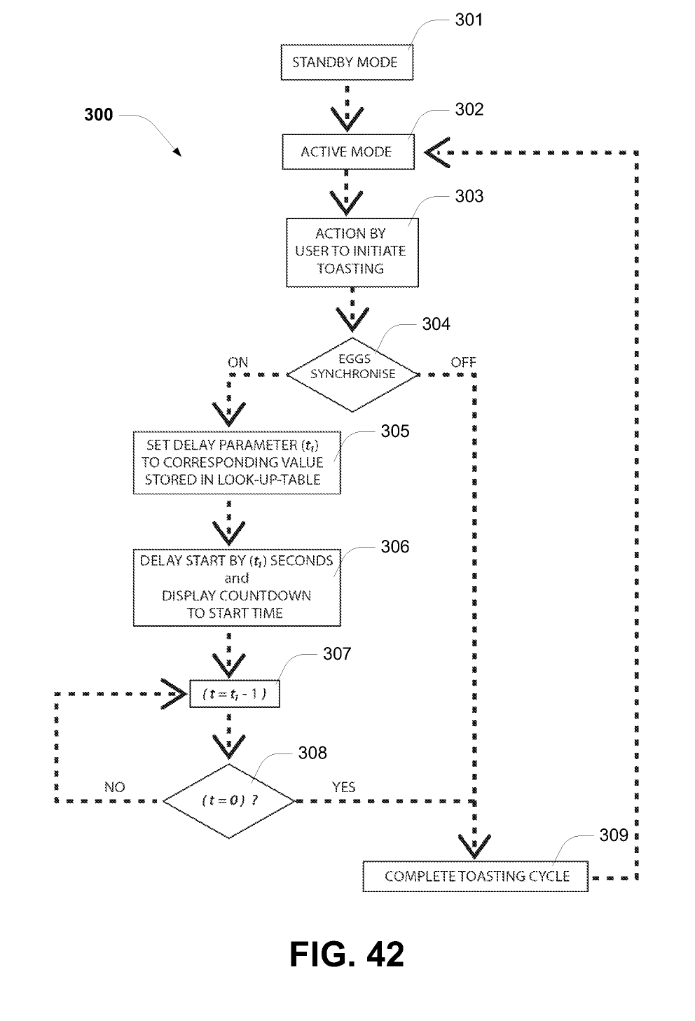

As suggested by FIG. 42, activation of the egg synchronizing timer delays the initiation of this toasting cycle by an interval equal to the difference between the stored cooking time for the selected egg style and the toasting duration associated with the parameter selections made by the user.

Alternatively, by way of example only, activation of the egg synchronizing timer can initiate a toasting cycle and indicate a egg start delay—being an interval equal to the difference between the stored cooking time for the selected egg style and the toasting duration associated with the parameter selections made by the user.

FIG. 42 shows a flowchart for a method 300 for activation of an egg synchronizing timer delay. The method comprising the steps of:
STEP 301: a ‘Standby’ mode, which transitions to STEP 302;
STEP 302: an ‘Active’ mode, which can transition to a STEP 303 upon a users selection;
STEP 303: an initiation action by the user, which can transition to a STEP 304 upon a users selection to start (for example pressing a start button);
STEP 304: if ‘egg synchronisation’ is enabled transition to STEP 305, otherwise transition to STEP 309;
STEP 305: set a delay parameter based on a predetermined value, transition to STEP 306
STEP 306: delay start and display countdown, transition to STEP 307;
STEP 307: decrement delay time and display countdown, transition to STEP 308;
STEP 308: if decrement delay time remains transition to STEP 307, otherwise transition to STEP 309;
STEP 309: commence/complete toasting cycle, transition to STEP 302.

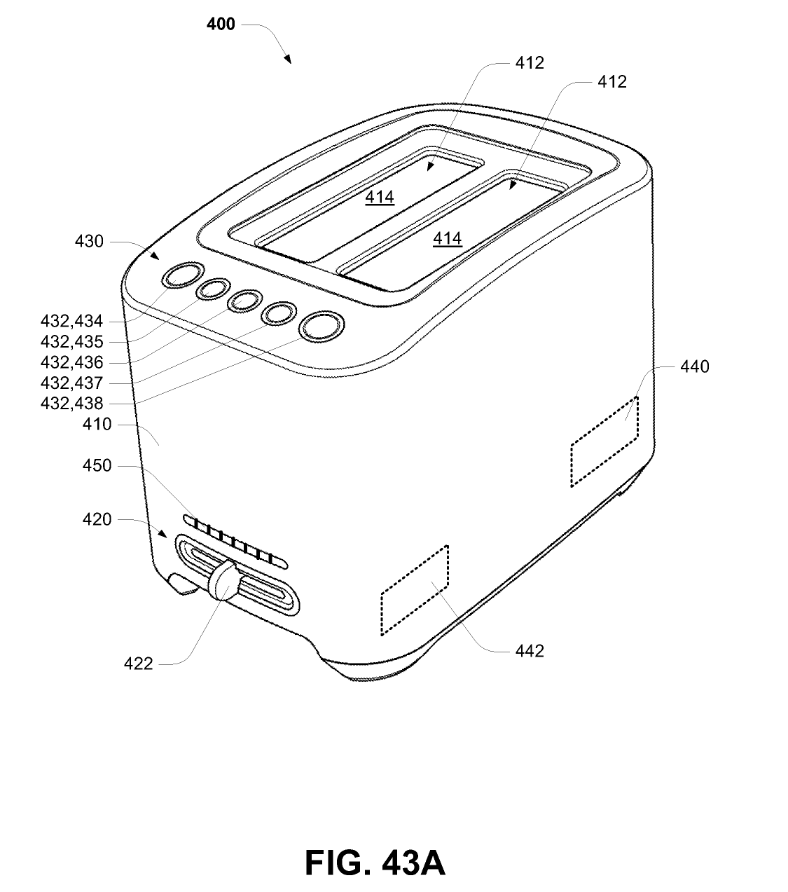

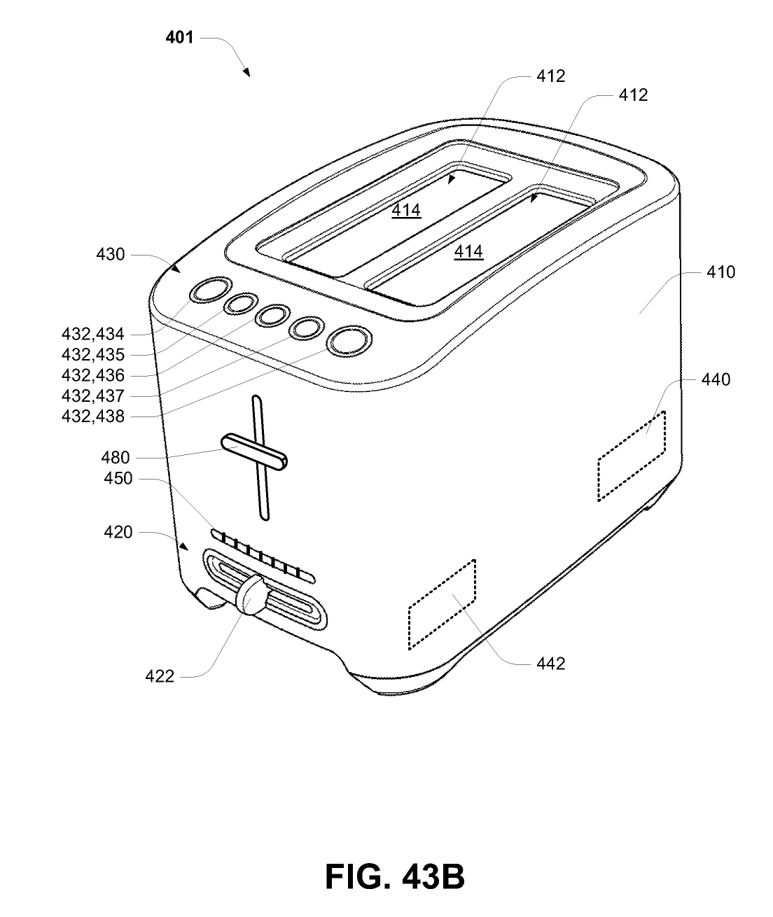

FIG. 43A and FIG. 43B show a food toaster apparatus 400, 401. The toaster including an user interface 410 for selectively enabling a primary toasting cycle or secondary toasting cycle.

Throughout the specification, the term “food” will be used to designate all appropriate comestible products, unless otherwise specified. For example, such foods include breads such as wholemeal breads, bagels, pastries, conventional sliced breads as well as frozen versions of all of these aforesaid examples. Use will also be made of the term “toasting cycle”. A toasting cycle is a process that begins with the presence of food in the toasting cavity and ends with the extinguishing of the heating elements and ejection of the food in those toasters that act to eject the food (some toasters do not eject the food). The term “toasting cycle” may also refer to defrosting. The use of the term “toasting cycle” is made without reference to the initial temperature of the toaster or the toasting cavity. The phrase “supplemental cycle” refers to both the lengthening of a toasting cycle or a second new cycle that supplements a first or initial cycle.

Reference will be made throughout the specification to the word “shade”. For the purpose of the examples provided in the specification, the range of toasting times is divided into five “shades”. The lowest degree of toasting or browning is referred to as “shade 1”. The longest duration toasting and thus the most brown is designated as “shade 5”. The display of a toaster may only indicate, say, five basic intended shades, but additional shades for a given food may be available when a user positions a sliding adjustment lever, mechanism or adjustment knob to a position between any two of the five basic shades.

Referring to FIG. 43A the food toaster 400 comprises a cover 410 below which is located a chassis having moveable toast racks. The toaster further includes one or more cooking slots 412, the slots leading to an internal toasting cavity 414. The exterior of the toaster features a toast shade selection element 420 and user interface 430. By way of example, the toast shade selection element 420 is in the form of a slider (or knob or selection mechanism) 422. By way of example, the user interface including a plurality of control buttons 432 (or switches or selection mechanisms etc). A processor element 440 is coupled to the toast shade selection element 420 and user interface 430 for receiving user selections. The processor element controls, activates and times the operation of the heating elements and toast rack mechanism.

A toaster's display element 450 may feature an array of indicators such as LED lights that may be used for a variety of purposes. The term “array” is intended to include linear or other abstract graphical arrays or alpha numeric arrays. The array may be used to provide a visual feedback of the initial toast cycle setting, more lights or different alphanumeric characters in the array being illuminated to indicate a higher setting. By way of example, the display element 450 may also be used as the display of a countdown timer, wherein the lights flash (or otherwise change) while a cycle is in progress and being extinguished or altered (e.g. alphanumerically), in an orderly way, to indicate the amount of time remaining in the cycle. In other example embodiments, the display element 450 may be used mid-cycle to indicate that an adjustment to the cycle time has been requested by the user. In a count down mode, the appearance of additional lights or different alphanumeric characters indicates (that owing to one of a variety of schemes) additional time has been requested by the user.

Referring to FIG. 43A, a motorised toaster can include motor 442 controlled by the processor element 440 for raising and lowering the toast rack mechanism. In this example embodiment, the “on” button 434 can send the appropriate switching signals to the processor element 440. The processor element 440 in such a slotted toaster controls the heating elements and the toaster's motor 442. The motor drives the slotted toaster's food racks. It will be appreciated that the teachings of the invention may be applied to electric toaster ovens for food as well as toasters with slots. Both are referred to as “food toasters” or “toasters”.

Referring to FIG. 43B, a manual toaster may have an activation handle 480 for lowering the food and initiating the processor element 440 that activates and times the operation of the heating elements. A motorised or automatic toaster will conventionally not have a handle.

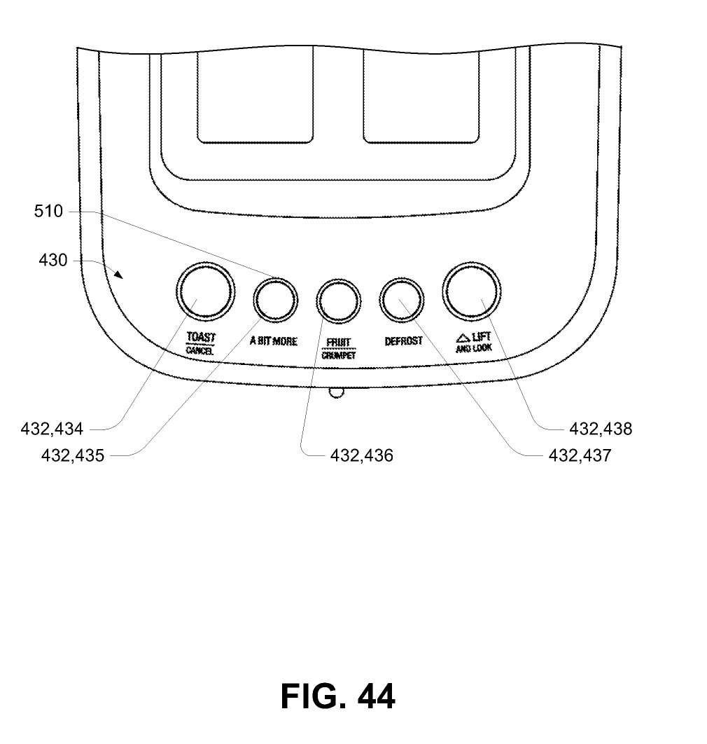

As best shown in FIG. 44, in an example embodiment, the user interface 430 control buttons are coupled to the processor element and can optionally include any one or more of the following:
an “on” button 434 for initiating or terminating a toasting cycle;
one or more “supplemental cycle” buttons 435 (or switches or activators) for specifying special cycles;
one or more “special cycle” buttons 436, 437 (or switches or activators) for selective specifying special toasting cycles;
an “inspection” button 438 for initiating a mid-cycle visual inspection.

By way example only, the “supplemental cycle” button (or “A bit more”™ button) 435 can operate in either of two ways. Firstly, if the “supplemental cycle” button 435 is depressed during a toasting cycle, current toasting cycle time is increased or lengthened, as will be explained. Secondly, if the “supplemental cycle” button 435 is depressed after the termination of a toasting cycle, a new cycle or after-cycle will be initiated and carried out, as will be explained.

By way of example only, the one or more “special food” buttons 436, 437 can enable selective specification of special cycles such as a sweet bread (such as fruit loaf) cycle, a bagel cycle or crumpet cycle, a defrost cycle or the like. It would be appreciated that a single special food button could be coupled to the processor element and be used to cycle between a plurality of special food modes or settings. The special food mode selected could then be indicated, by way of example only, by either a display element (such as a peripheral LED) associated with the selector button or the display array.

By way of example only, a mid-cycle inspection button 438 can enable visual inspection of the toast without interrupting the operation of the heating elements. For example, in a motorised toaster apparatus, the motor can elevate the racks that carry the food, such that the food emerges from the slots for user inspection, the food then being lowered by the motor back into the toasting cavity without undue delay—wherein use of the mid-cycle inspection button 438 does not affect the duration of the toasting cycle. For example, in a manual toasters, a mid-cycle inspection cycle can be achieved by lifting the handle 480 mid-cycle, thereby to elevate the partially toasted food for user inspection, and then allowing the lever to return to its lowered position—wherein use of the mid-cycle inspection cycle in a manual toaster does not affect the duration of the toasting cycle.

It will be appreciated that the teachings of the present invention, apart from the specific methods of electromechanically implementing them are equally applicable to both manual and motorised toasters.

### Supplemental Cycle

Various embodiments illustrating the use of a supplemental cycle will now be disclosed by way of example only.

### Fixed Supplemental Cycle

By way of example only, a fixed supplemental cycle can be initiated. In the most basic embodiments, depression of the supplement button 435 results in the delivery of a toasted food that is approximately one half shade darker than the shade originally requested.

In a manual toaster, and in the most basic form of the invention, activation of the supplemental heat button or activator 435 can have two results. If the button or activator is activated during a toasting cycle, a fixed amount of time is added to the duration of the cycle in progress, regardless of what shade the user had initially requested. For example, activation of the button during the toasting cycle might add seconds to the duration of the cycle. Where the supplemental heat button is depressed after the completion of a toasting cycle, a supplemental toasting cycle will be initiated after the user depresses the activation lever of the toaster. This supplemental cycle is shorter than the initial or first requested cycle but calculated to darken the food already in the toaster. In this example, if twenty seconds is added during a mid-cycle supplement, then operation of the supplemental heat button after that initial toasting cycle might result in a forty second supplemental cycle being initiated the next time the activation lever is depressed. Less time is required mid-cycle because the toaster is already hot. If the supplemental heat button were depressed again before the activation lever were operated, the supplemental heat function would be cancelled and the user would be initiating a new normal cycle rather than a supplemental cycle on the next use.

In a manual toaster, and in the most basic form of the invention, use of the supplemental heat button or activator 435 causes an indicator to be illuminated by the processor. The indicator may be an annular light 510 surrounding the activator 435 or an illuminated indication (graphical or alphanumeric) provided by the display array 450. The indicator is not extinguished by the processor until the supplemental cycle is completed or the activator is again depressed by the user to cancel the supplemental cycle or the request for same.

In a motorised toaster, activation of the supplemental heat button or activator 435 during a toasting cycle can be similarly used to add a fixed amount of time to a given toasting cycle. Activation of the supplemental heat button or activator after the completion of a toasting cycle causes the food to descend once again into the toasting cavity 414 under the influence of the toaster's motor 442. This can happen as soon as the button 435 is depressed or may require the depression, in turn, of both the supplemental heat button 435 and the activation or “on” button 434. The supplemental heat cycle thus initiated will last a fixed amount of time regardless of the previous toast cycle setting. The display array LED indicator 450 may be used to display the progress of the initial as well as the supplemental toasting cycles.

In a motorised toaster, use of the supplemental cycle button or activator 435 causes an indicator to be illuminated by the processor. The indicator may be an annular light 510 surrounding the activator 435 or an illuminated indication (graphical or alphanumeric) provided by the display array 450. The indicator is not extinguished by the processor until the supplemental cycle is completed or the activator is again depressed by the user to cancel the supplemental cycle or the request for same.

Fixed Supplemental with Adjustment Cycle

By way of example only, a fixed supplemental with adjustment cycle can be initiated.

In either a manual or a motorised toaster, use of the supplemental heat button 435 can be augmented by giving the user additional control over the duration of the supplemental cycle. This can be done by having the toaster's microprocessor recognise an input from the toast cycle selection lever or knob or mechanism 422 as a modification to a heat supplement. For example, a mid-cycle extension of twenty seconds, initiated by the use of the heat supplement button, can be varied by, say, ten seconds either way by using the toast selection lever or knob after the supplemental heat button has been pressed. This may be accompanied by a visual display on the LED array display 450 that is representative of the adjustment requested by the user. The toast cycle selection lever can also be used as an adjustment to an after-cycle or a “new” supplemental cycle by adjusting the toast cycle selection lever of knob after an initial toasting cycle has been completed and after the supplemental heat button has been depressed.

Again, use of the supplemental cycle button or activator 435 causes an indicator to be illuminated by the processor. The indicator may be an annular light 510 surrounding the activator or an illuminated indication (graphical or alphanumeric) provided by the array display 450. The indicator is not extinguished by the processor until the supplemental cycle is completed or the activator is again depressed by the user to cancel the supplemental cycle or the request for same.

It will be appreciated that the increase in the duration of a cycle referred to above can be a fixed duration regardless of the initial toast cycle selection setting, or can be initially fixed, then modified by user input. It should also be appreciated that the extent of the fixed increase (either mid-cycle or after-cycle) can be different depending on the food in the toaster and whether or not it is frozen, for example, whereas a fixed mid-cycle extension of time may be twenty seconds, it might be fifteen seconds if the bagel button had been depressed or thirty seconds if a defrost button had been depressed. Thus, the use of the supplemental heat button can result in different fixed extensions of toasting time being applied, in different circumstances (mid-cycle or after-cycle) and result in different times being applied depending upon the toasting regime (normal, bagel or defrost).

### Algorithmic Supplemental Cycle

By way of example only, an algorithmic supplemental cycle can be initiated. Examples have been provided above that show how a fixed period extension of time can be applied during or after a normal toasting cycle. In alternate embodiments, rather than apply a fixed interval, the mid-cycle extension, new or after-cycle supplemental cycle is determined by an algorithm related to the initial toast cycle selection setting and optionally other input factors as well. Input factors that the algorithm may consider include e.g. the type of food in the toaster, the shade setting, the actual or inferred temperature in the toasting cavity, whether frozen food is in the toaster etc. For example, a user may have set the toast cycle selection lever or knob 422 to ‘shade 3’ and determined, by using the mid-cycle inspection feature 438 that the bagel was, to their liking, under toasted. Subsequent depression of the supplemental heat button 422, in this example, causes the processor element 440 to run an algorithm that determines that the normal duration (for example, 156 seconds) should be extended (for example, by 20%). This results in the microprocessor adding an additional toast term (for example, 31 seconds) to the cycle time, thus resulting in a total cycle time (for example, 186 seconds). Similarly a new or after-cycle supplemental cycle can be adjusted in its duration by a time period determined by an algorithm that takes into account one or more input factors.

In accordance with the above teachings, an increase can also be modified by the user by adjustment of the toast cycle selection lever 422, in the way indicated above. The user modification to the supplemental heating period can be done by adding a fixed time, a fixed percentage or a situation dependent variable period to the supplemental time.

### Supplemental Cycle Adjustment Based on Delay

By way of example only, a supplemental cycle adjustment based on delay can be initiated.

With reference only to the use of the supplemental heating button 435 as a means of initiating a new and supplemental toasting cycle (in either a manual or motorised toaster) adjustment of the supplemental cycle duration (based on any of the above methods) can be made by taking into account the delays since the last time the heating elements of the toaster were switched off. The toaster's microprocessor can determine the time interval since the elements were last switched off. This interval in time can be interpreted as an indication of the toaster's internal temperature. When the interval is short, the toaster will be hotter than when the interval is long. Thus, the supplemental cycle can be adjusted to account for the extrapolated (or directly measured) internal temperature of the toaster. The cycle will be shortened when the aforementioned delay is shorter and may be lengthened when the delay is longer.

### Special Cycle Modes

Various embodiments illustrating special cycles (or special cycle modes of operation) will now be disclosed by way of example only.

By way of example only, the one or more “special food” buttons 436, 437 can enable selective specification of special cycles such as a sweet bread (such as fruit loaf) cycle, a bagel cycle or crumpet cycle, a defrost cycle or the like —thereby each defining a respective secondary toasting cycle. It will be appreciated that, in some embodiments, one or more of the “special food” buttons 436, 437 can be simultaneously enabled—thereby creating further secondary toasting cycles.

In an embodiment, selectable special toasting cycles can include a sweet bread cycle for selectively specifying toasting of a sugar rich food such as a fruit loaf slice. In the a sweet bread cycle a secondary toast duration is configured to define a secondary toasting cycle. In the special secondary toasting cycle configured for cooking a sugar rich food, the toast duration is decreased or reduced from that indicated by the toast shade selection element using a primary toasting cycle (i.e. a primary toast duration when special toasting cycles are not selected). The secondary toast duration can be calculated from the primary toast duration or obtaining from a lookup of a toast duration table, as discussed below. In this embodiment, all heating elements are active when toasting. It will be appreciated that an alternative a secondary toasting cycle may require an increased or longer cooking time to be calculated or looked-up, and alternative heating elements configurations are enabled.

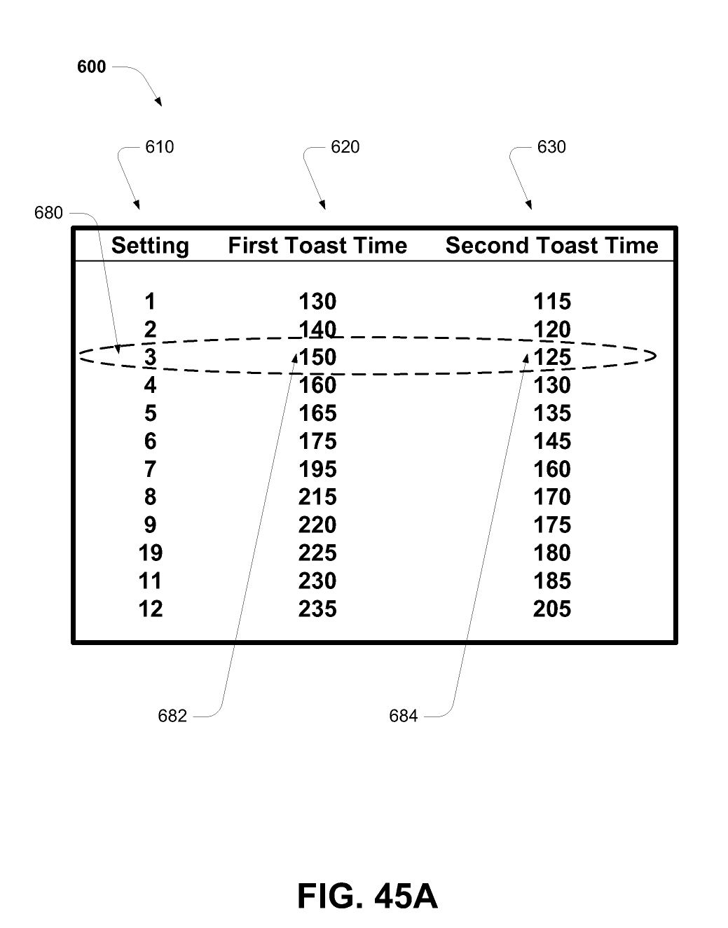

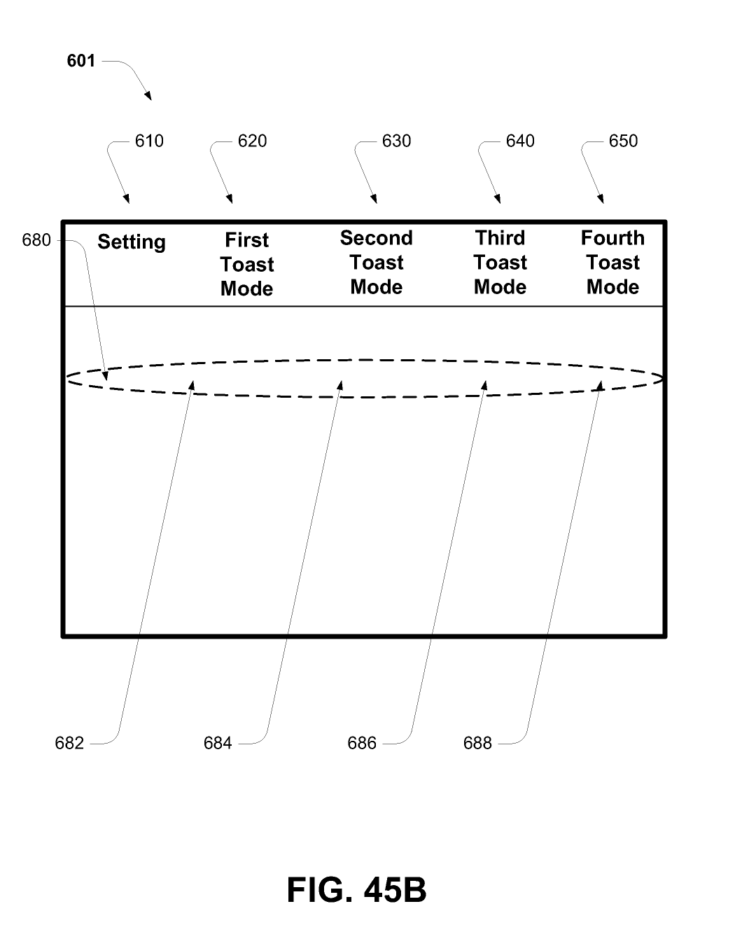

Referring to FIG. 45A, in an example embodiment, the secondary toast duration (for example for a sweet bread or fruit toast) can be obtained from a lookup of a toast duration table 600. In this toast duration table 600, for each setting 610 (for example corresponding to the toast shade selection element 420), respective primary toast duration times 620 and secondary toast duration times 630 are available. In this example, with a toast shade selection element selecting ‘shade 3’ 680: without a “special food” button selected, a primary toast duration time 682 of 140 seconds will be used; with a “special food” button selected, a sweet bread cycle selected, a secondary toast duration time 684 of 120 seconds will be used. It will be appreciated that a separate lookup table or column can be associated with each of the special cycle modes (singularly and in combination). It will be appreciated that a separate lookup table or column can be associated with particular special cycle modes (singularly or in combination), while the obtained toast duration time associated with the selected particular special cycle modes can be increased or decreased according to a calculation (for example, being fixed and/or dependent on the toast shade selection, and/or dependent on a user selection) or predetermined amount (for example, being fixed and/or dependent on the toast shade selection, and/or dependent on a user selection) for the remaining selected special cycle modes.

In an embodiment, selectable special toasting cycles can further include a bagel cycle. In the bagel cycle, only the elements between adjacent slots are activated. A user will normally be instructed to use specific adjacent slots for toasting a bagel, with the cut faces of the bagel facing one another in the adjacent slots.

In an embodiment, selectable special toasting cycles can further include a defrost cycle. In the defrost cycle, the heating element may operate at a reduced power for an initial period or for the entire toasting cycle. The toast duration can be calculated by adding a fixed term or a adding a term proportional to a primary toast duration. Operation of the defrost cycle can be active separately or in combination with another “special food” buttons.

By way of example only, FIG. 45B represents a lookup table 601 that is adapted to support a plurality of (e.g. four) “special food” modes. By selection of the “special food” mode (620, 630, 640, 650) using the user interface 430, and selection of the toast shade using toast shade selection element 420, the processor element can determine selected toast shade 680 and respective toasting period (682, 684, 686, 688).

It would be appreciated that a single special food button could be coupled to the processor element and be used to cycle between a plurality of special food modes or settings. The special food mode selected could then be indicated, by way of example only, by either a display element (such as a peripheral LED) associated with the selector button or the display array.

### Motorised Toaster

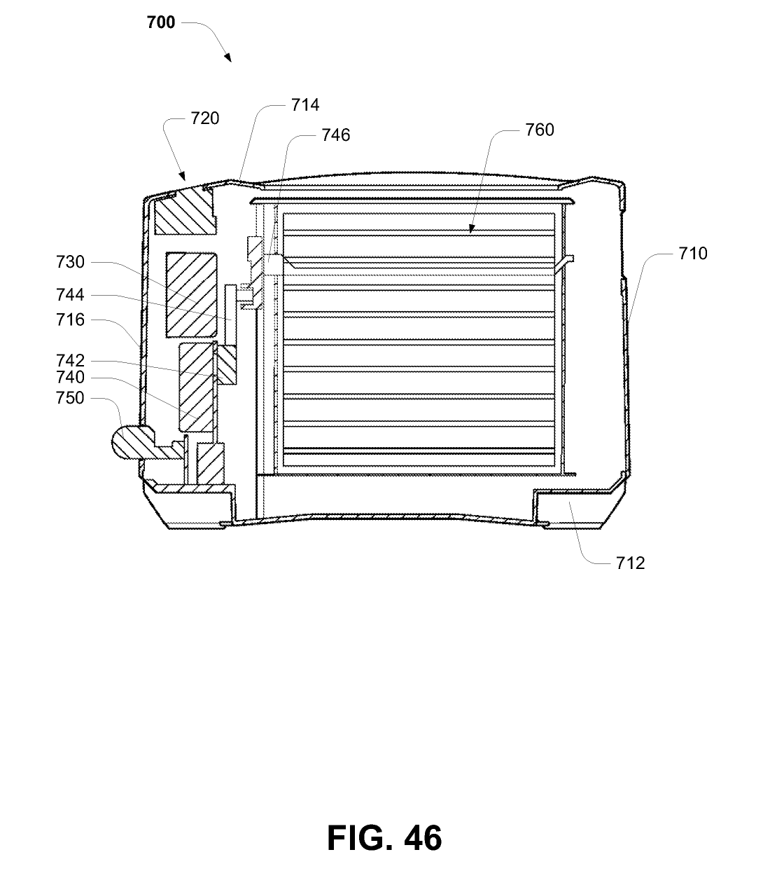

FIG. 46 shows an embodiment motorised toaster 700. This toaster comprises a main housing 710 that is supported on rubber feet 712. In this example, an upper surface 714 presents electronic, button activated, user interface (comprising inputs or controls) 720. These user inputs are supplied or communicated to a processor element (for example, a main printed circuit board (PCB) or other means) 730 for controlling (exercising electronic control) over an electric motor 740. The processor element (PCB or other means) 730 may also control other aspects of the operation of the toaster.

The housing 710 has an end panel 716 comprising a slot in it through which protrudes a toast shade selection element (or slider) 750 with which the user can adjust the duration of the toasting cycle. Information relating to the slider position is transmitted to or gathered by the processor element.

Under the control of the processor element 730, the motor 740 and its gearbox 742 cause a rotating motor arm 744 to influence the motion of a reciprocating toast carriage 746. The motor arm is coupled to the carriage in such a way that the toast carriage can be lowered at the inception of a toasting cycle and elevated at the end of a toasting cycle without the need for user intervention.

The apparatus is further adapted to provide a user with an automated visual inspection feature. With the toast carriage in a lowered position that corresponds with the toaster's heating elements 760 being energised or “on”. The carriage is lowered into this position by the action of the motor under the control of the processor element. It may remain in this lower position for the full duration of the toasting cycle. At the end of the cycle, the processor element causes the motor to elevate the carriage back to the raised position.

However, by way of example only, at any time during the toasting cycle, a user may initiate an inspection subroutine. The user pushes or otherwise activates an electronic control 720 to initiate the subroutine. Activating the control causes the processor element to elevate the carriage to the raised position for a relatively short period of time. While the carriage is in this raised position, the heating elements preferably remain on. In this upper position, the user can visually inspect the toast. Typically, the inspection subroutine lasts about seven seconds. That is to say that the carriage is elevated from its lower-most (or lowest) position and returns to this lower-most position in about seven seconds and without user intervention. In preferred embodiments, the duration of the inspection subroutine is added to the duration of the toasting cycle. In the previous example, this will result in a toasting cycle being extended by the seven seconds that were consumed by the inspection subroutine.

If during the inspection subroutine, a user observes that the toast is done to satisfaction, they can simultaneously terminate both the subroutine and the toasting cycle by depressing a cancel button or control 720. This will have the effect of turning off the heating elements and elevating the toast carriage to (or leaving it in) the fully raised position.

In some embodiments, the user controls 720 comprise a toasting cycle extension button. In preferred embodiments, extension of the toasting cycle may only be requested by a user after a regular toasting cycle ends. The depression of this button starts the toasting cycle extension and causes a series of events. Firstly it causes the processor element to move the carriage to the lowered position. The processor element then switches on the heating element for approximately forty seconds of toasting. It will be appreciated that the toasting duration can alternatively be determined as any time period provided by a table and/or calculated using one or more algorithms. Lastly the processor element elevates the carriage back to the raised position, thus ending the toasting cycle extension.

In particularly preferred embodiments, the toaster has user controls for both the inspection subroutine and the toasting cycle extension. In these embodiments, the inspection subroutine may be activated during the toasting cycle extension. The activation of the inspection subroutine interrupts the toasting cycle extension in the manner previously described. This interruption lengthens the overall duration of the toasting cycle extension by the amount of time the inspection subroutine requires. However, the toasting cycle extension cannot typically be activated during the inspection subroutine.

### Selective Heating Elements

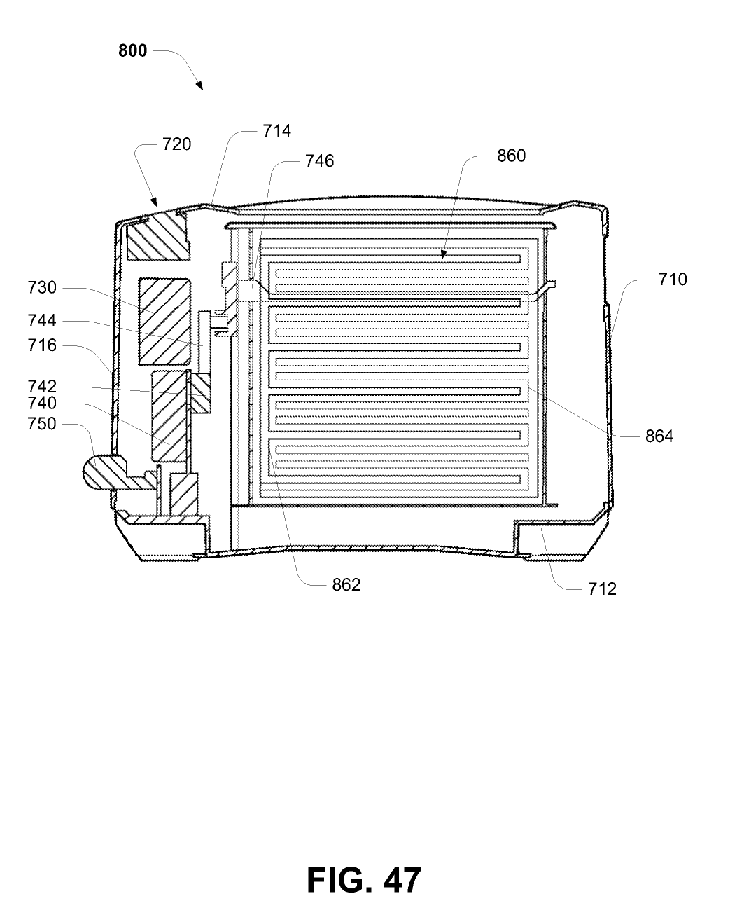

FIG. 47 shows an embodiment motorised toaster 800, which is similar to the toaster 700 of FIG. 46. In this embodiment motorised toaster 800, the heating element 860 has selective heating output.

In this embodiment, the heating element 860 can comprise of two or more separate wire elements. The elements can be enabled (powered) individually or concurrently.

By way of example, the heating element 860 can comprise two separate wire elements 862, 864, which can be enabled (or powered) individually or concurrently—thereby providing different power configurations. In this example, the two separate wire elements 862, 864, are each constructed with different numbers of wire winds (or wire runs)—and thereby each provide a different power output. By enabling (or powering) these separate wire elements 862, 864 individually or concurrently—three different power configurations can be defined.

It will be appreciated the heating element 860 can be used in combination with any of the embodiments disclosed herein.

In further embodiments, by way of example only, a user interface can include operating a “supplemental cycle” button (or “A bit more”™ button). It will be appreciated that a user interface can comprising on of a plurality of input elements in combination with any one of a plurality of display elements.

A toaster's display element or area may feature an array of indicators such as LED lights that may be used for a variety of purposes. The term “array” is intended to include linear or other abstract graphical arrays or alpha numeric arrays. The array may be used to provide a visual feedback of the initial toast cycle setting, more lights or different alphanumeric characters in the array being illuminated to indicate a higher setting. The array may also be used as the display of a countdown timer, the lights flashing or otherwise changing while a cycle is in progress and being extinguished or altered (e.g. alphanumerically), in an orderly way, to indicate the amount of time remaining in the cycle. In other embodiments, the array can be used mid-cycle to indicate that an adjustment to the cycle time has been requested by the user. In a count down mode, the appearance of additional lights or different alphanumeric characters indicates (that owing to one of a variety of schemes) additional time has been requested by the user.

A supplemental cycle was described both herein and in United States Patent Publication No. US 2008/0203085, which is incorporated herein by reference.

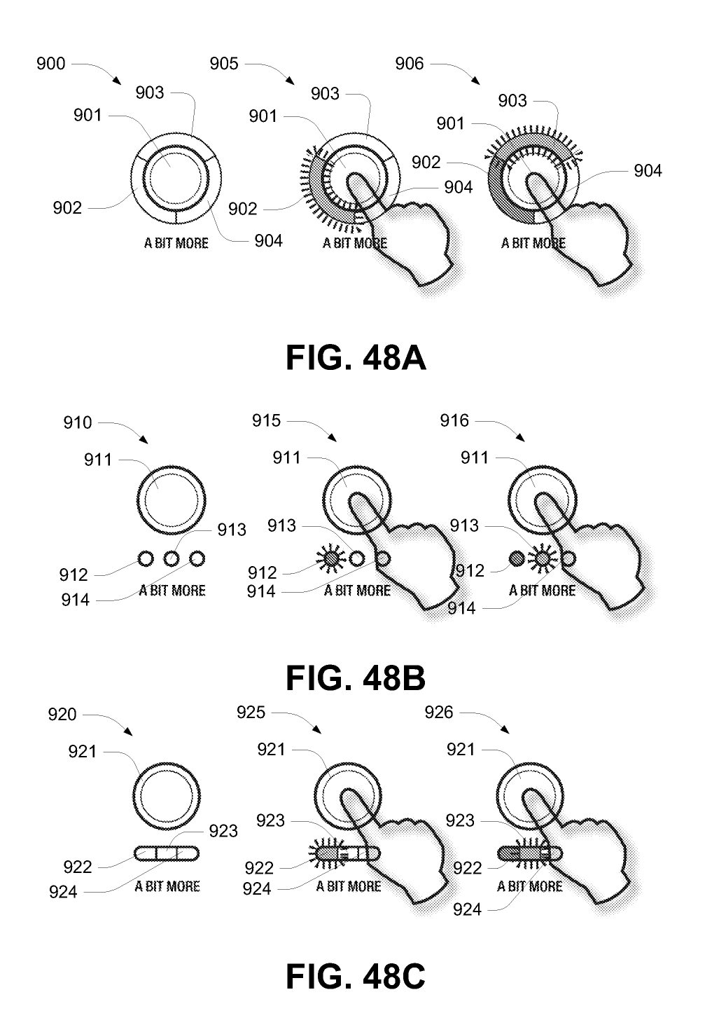

FIG. 48A shows an embodiment user interface 900 for operating (or initiating) a “supplemental cycle”. In this embodiment, the interfaces includes an input button 901 and a segmented circumferential display element (902, 903, 904) about the button. For example the display element can display one of three supplemental settings as shown by reference 905 indicating selection of a single supplemental cycle period, and by reference 906 indicating selection of two supplemental cycle periods.

FIG. 48B shows an embodiment user interface 910 for operating (or initiating) a “supplemental cycle”. In this embodiment, the interfaces includes an input button 911 and a plurality of independent display elements (912, 913, 914). For example, the display element can display one of three supplemental settings as shown by reference 915 indicating selection of a single supplemental cycle period, and by reference 916 indicating selection of two supplemental cycle periods.

FIG. 48C shows an embodiment user interface 920 for operating (or initiating) a “supplemental cycle”. In this embodiment, the interfaces includes an input button 921 and a plurality of independent display elements (922, 923, 924) configures in a linear display. For example, the display element can display one of three supplemental settings as shown by reference 925 indicating selection of a single supplemental cycle period, and by reference 926 indicating selection of two supplemental cycle periods.

It will be appreciated that a display element(s) can be configured to indicate changes in supplements cycle selection by visually flashing or changing colour. An auditory sound may also be used.

It will be appreciated that the number of selectable supplements cycles can be associated with selecting a supplemental operating period between zero and one standard setting period (for example darkness setting). For example, in the above examples, where the display elements show one of three possible supplemental cycle setting, the supplemental operating period can be a quarter, a half and three quarters of the standard setting period. In other embodiments alternative ranges/configurations are also possible.

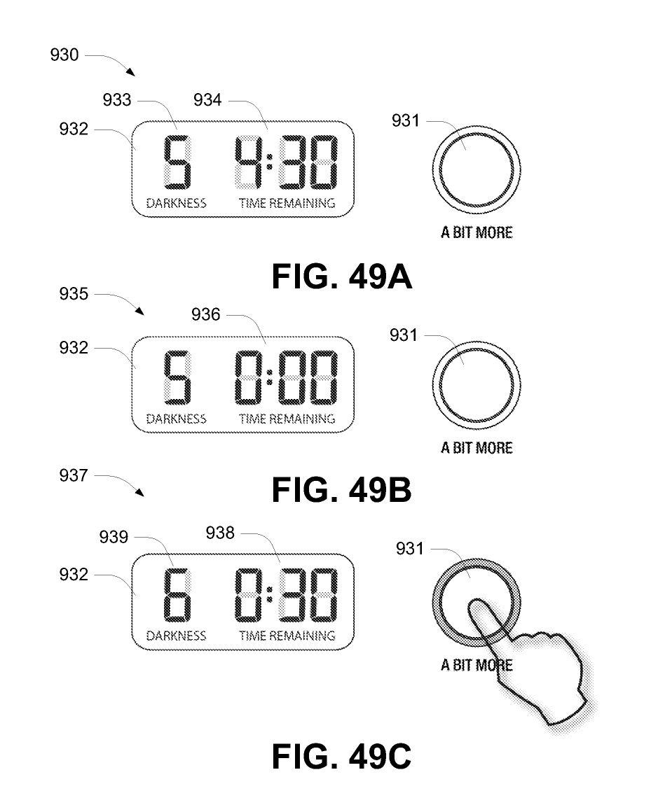

FIG. 49A through FIG. 49C shows an embodiment user interface 930 for operating a “supplemental cycle”. In this embodiment, the interfaces includes an input button 931 and a display element 932 having indicators for the current setting 933 and time remaining 934. As show in reference 935, the time remaining can reduce to zero at the end of a primary cycle. As shown in reference 937, the input button 931 can be input to select a desired supplemental cycle period, which for the example is a further 30 seconds 938 and one darkness setting 939. Alternatively, the input button can be input to select a desired supplemental cycle period during the primary cycle.

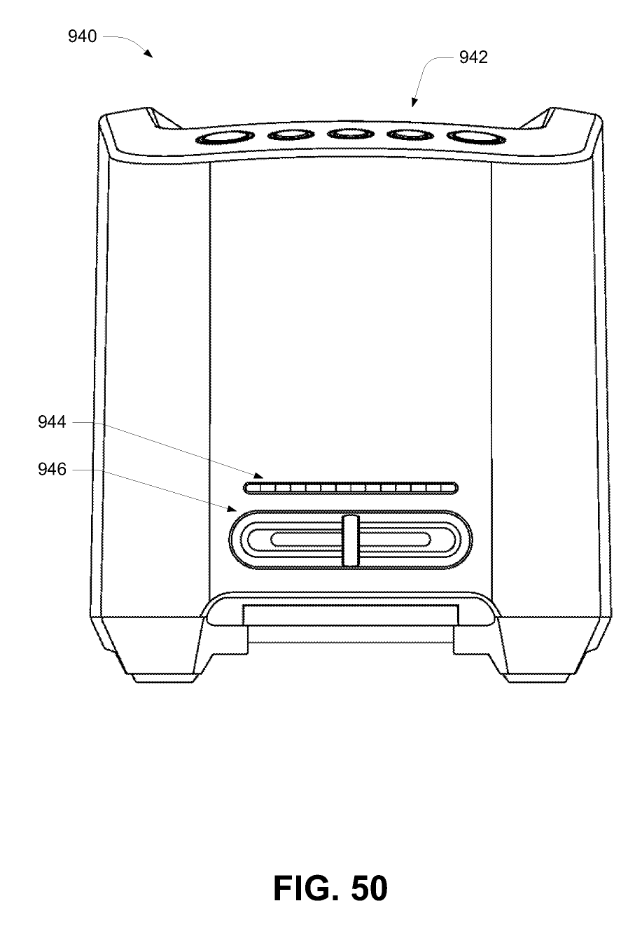

FIG. 50 shows an embodiment user interface 940 for operating a “supplemental cycle”. In this embodiment, the interface includes an input button 942 located atop the device and a display element 944 located above the darkness input slider 946.

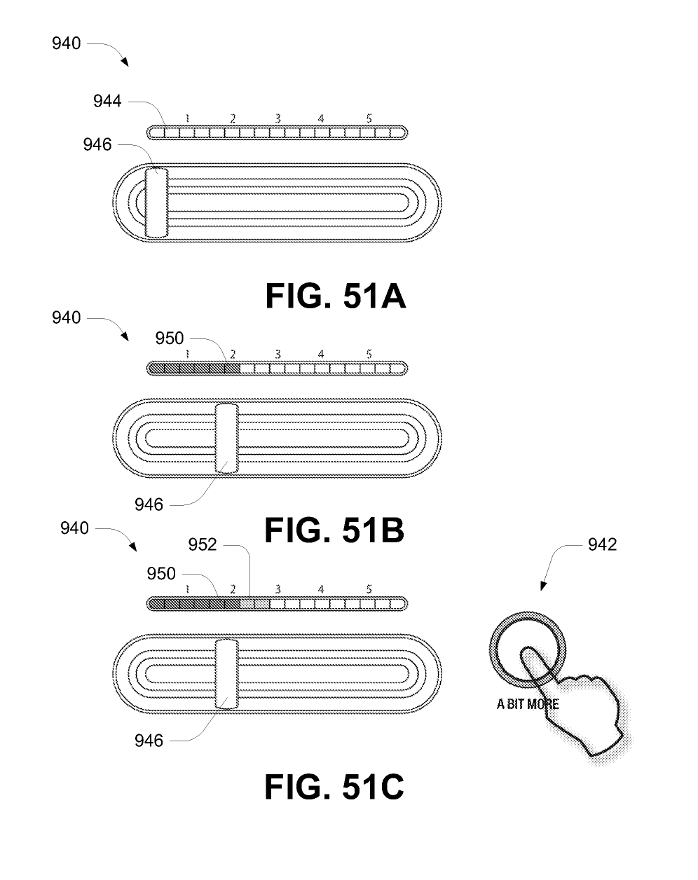

Referring to FIG. 51A through FIG. 51C, the user interface 940 can be used to select a first primary cycle period by moving the slider 946 to a first setting as indicated by the display element at 950. A supplemental cycle can then be selected by operating the input button 942, as indicated by the display element at 952.

It will be appreciated that, by way of example only, selection of a supplemental cycle period (or increasing a supplemental cycle period) can be made by holding down an input button, repeated pressing of an input button, rotation of an input button, or sliding of an input button. The input button can be input to select a desired supplemental cycle period after or during a primary cycle.

### Keep Warm Feature

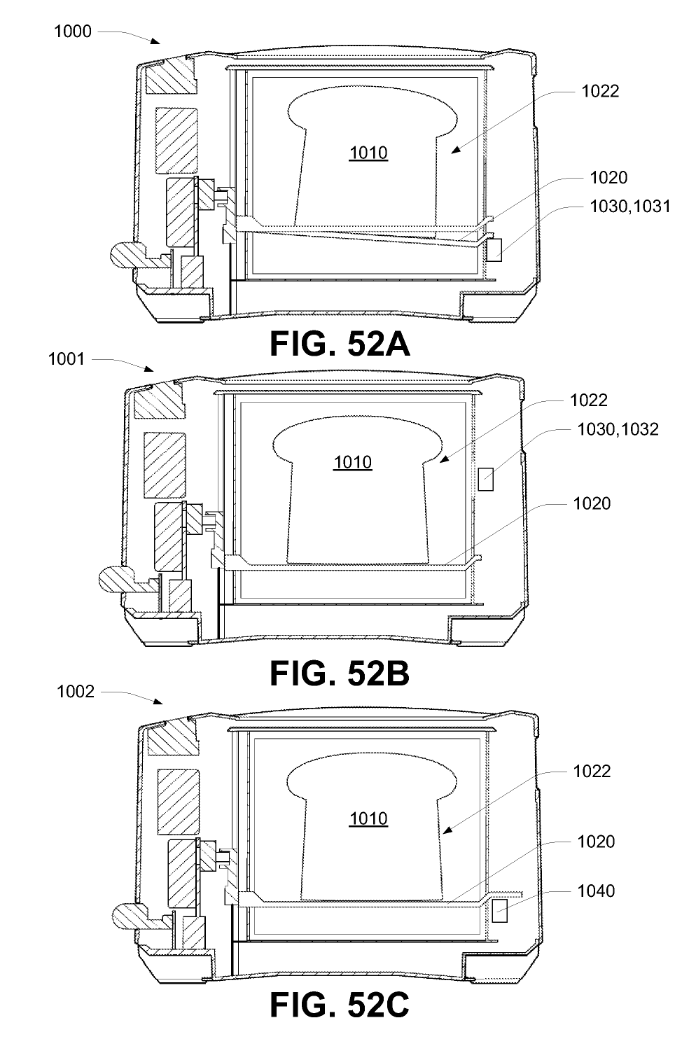

FIG. 52A through FIG. 52C show schematic views of embodiment toaster apparatus having a keep warm feature. It will be appreciated that a keep warm feature may be incorporated in the embodiment toaster apparatus disclosed herein. This keep warm feature may be automated in an automatic toaster.

FIG. 52A and FIG. 52B shows an embodiment toaster apparatus (1000, 1001, and 1002) incorporating a keep warm function or feature. The keep warm function or feature can monitor the presence or persistence of a toast slice 1010 after completion of a toasting cycle, and can operate to commence a keep warm operation. In a keep warm operation, the carriage 1020 (and toast) is moved to a lowered configuration within the toasting chamber 1022 for maintaining temperature of, or keeping warm, the toast.

The presence of the toast can be monitored using a sensor 1030 (for example, a weight sensor or switch sensor or capacitive sensor 1031, or an optical sensor or infra-red sensor 1032). Further the location of the toast carriage can be monitored through use of a sensor 1040 (for example, weight sensor, switch sensor, capacitive sensor, optical sensor or infra-red sensor).

It will be appreciated that, in an embodiment, automatic operation of the keep warm cycle allows for the automatic lowering of the toast during a nominal cycle. When toast is placed on the carriage the toast may be lowered after a predetermined time and or once the chamber has reached a sufficient cooking temperature.

It will be appreciated that the keep warm function can monitor the presence or persistence of the toast for a pre-determined time after completion of a toasting cycle before commencing the keep warm operation. Alternatively, the keep warm function can monitor the estimated temperature of the toast to estimate temperature of the toast having dropped below a pre-determined limit, before commencing a keep warm operation. Temperature of the toast can be directly measured or estimated indirectly through monitoring the residual temperature in the toasting chamber.

Upon moving the carriage into the lowered configuration, with the toast in the toasting chamber, the toasting elements can be activated to reheat (or keep warm) the toast.

The keep warm operation can operate over a predetermined time period, and/or having a predetermined power setting for the toasting elements being activated, before concluding a keep warm operation. Alternatively, the temperature of the toast being kept warm can be monitored (directly or indirectly) to estimate temperature of the toast having reached a pre-determined keep warm limit, before concluding a keep warm operation. The keep warm operation will be typically performed only once. In some embodiments, the keep warm operation can be repeatedly performed to a predetermined limit. In some embodiments, the keep warm operation can be repeatedly performed. The keep warm cycle may be cancelled at any time by preferably pressing a cancel button, or other recognised input by the user to cancel the cycle.

In some embodiments, by way of example, during the keep warm cycle the keep warm icon or switch may be illuminated to indicate to the user the status of the toaster apparatus. The icon or switch may flash and/or provide an assortment of acoustic alerts to indicate to the user the status of the toaster to indicate the start or completion of a cycle.

It will be appreciated that the automatic commencement of a keep-warm cycle can cause activation of the toasting elements having variable power settings or switchable power settings. Such operations of toasting elements are described herein.

### Pre-Heated Chamber

An embodiment toaster apparatus can further include a pre-heating function. Prior to lowering bread into the toasting chamber, a pre-heat function can be selected or activated. The pre-heat function can be automatically activated.

A pre-heat operation can be achieved by activating the toasting elements for a predetermined time prior to commencement of a toasting cycle. Alternatively, a pre-heat operation can be achieved by activating the toasting elements until the chamber reaches a predetermined temperature. After a pre-heat operation, a toasting cycle can commence

The pre-heat operation can be automatically activated, upon monitoring the time period since a previous toasting cycle, and/or monitoring the current toasting chamber temperature.

The toasting elements can operate with a variable or switched power output. A pre-heat operation may avoid overdying of the toast during the first cycle when the additional time is typically required to get the chamber up to temperature and achieve the desired toast colouring. This can allow for more repetitive toasting results between the first and second cycle.

In an embodiment, during the pre-heat operation a display icon or discreet switch or array of illuminated indicators (for example on a on a user interface) may be used to visually communicate to the user that the chamber in a pre-heat status. An acoustic alert may also be used to indicate the status to the user.

It will be appreciated that by controlling the toasting chamber temperature, a substantially consistent or optimal or repeatable toast colouring (or brownness) and moisture can be achieved.

### High-Lift Feature

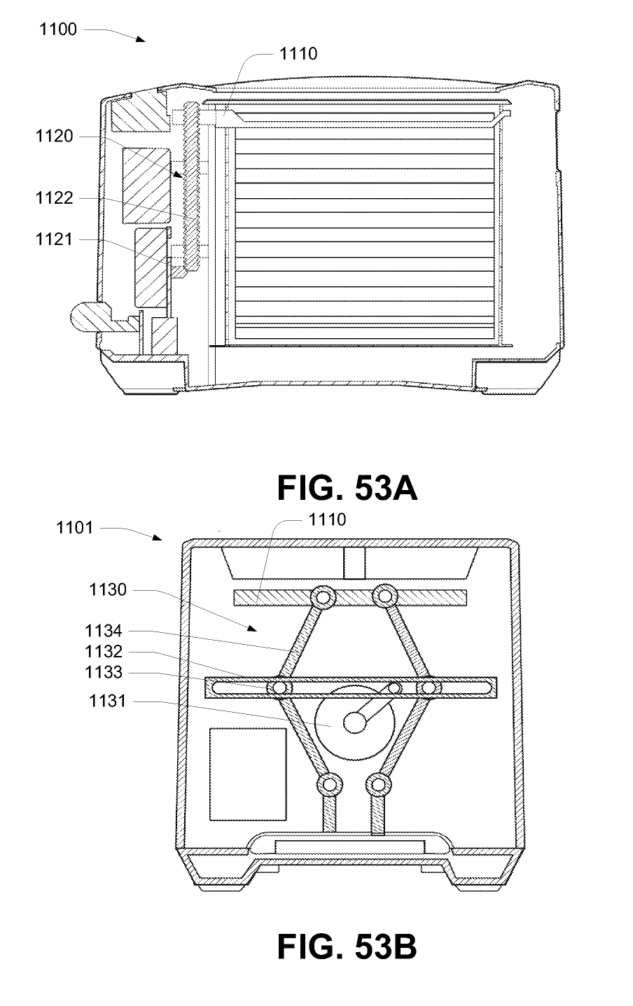

FIG. 53A through FIG. 53B show schematic views of embodiment toaster apparatus (1100,1101) having a high-lift feature.

FIG. 53A shows an embodiment toaster apparatus 1100 having a high-lift feature for moving a toast carriage 1110 being moved between a raised and lowered configuration using a screw lift assembly 1120. In this embodiment, by way of example, the screw lift assembly uses a worm gear 1121 engaging a threaded shaft 1122 attached to the carriage. The worm gear causes rotation of the shaft that threadedly engages the carriage, thereby moving the carriage into a raised or lowered configuration.

FIG. 53B shows an embodiment high lift toaster apparatus having a high-lift feature for moving a toast carriage 1110 being moved between a raised and lowered configuration using a scissor lift assembly 1130. In this embodiment, by way of example, scissor lift assembly includes a rotatable drive element 1131 that is mechanically coupled to a horizontal guide element 1132, such that rotation of the drive element causes the guide element to rise and/or lower. The guide element being slidably coupled to central linkages 1133 of a pair of scissor arms 1134, such that raising of the guide element causes the arms of the scissor lift to move inward to thereby raise the carriage—and lowering the guide element causes the arm linkages to move apart, thereby lowering the carriage.

It will be appreciated that other forms of the screw lift or scissor lift configurations can be used in raising and lowering the toast carriage.

The high lift feature can enable a user (during a toast cycle or upon conclusion of a toast cycle) to extend the lift of the carriage for providing more complete observation of the toast—which is useful for short or small pieces of breads or toast.

By way of example, this feature could be activated by holding down a lift and look button for an extended period.

Sensors can be used (for example optical sensors) in determining the bread height (for example relative to a known location of the carriage).

### Interpretation

It will be appreciated that the disclosed embodiments teach alternative toaster configurations.

While the present invention has been disclosed with reference to particular details of construction, these should be understood as having been provided by way of example and not as limitations to the scope or spirit of the invention.

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Similarly, it is to be noticed that the term “coupled”, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1-20. (canceled)

21. A motorised toaster apparatus, the apparatus including:
a body having one or more toasting slots leading to a respective toasting cavity; one or more internal carriage for carrying a food item, a carriage being associated with each toasting slot and respective toasting cavity; each carriage being movable between a predetermined raised configuration and a predetermined lowered configuration;
a plurality of toasting elements, wherein a toasting element is located at each side of each carriage;
a motor coupled to a lift assembly for moving one or more carriage to the raised configuration and the lowered configuration;
a microprocessor for controlling the motor;
wherein the lift assembly is further configured to selectively move the carriage to a high lift configuration in which the respective carriage is located higher than the raised configuration.

22. The apparatus according to claim 1, the apparatus further including a sensor coupled to the microprocessor for determining the bread height relative to a known location of the carriage.

23. The apparatus according to claim 1, the apparatus further including a sensor coupled to the microprocessor; wherein the location of a carriage can be monitored through use of the sensor.

24. The apparatus according to claim 3, wherein the sensor includes any one or more or the set comprising a switch sensor, a capacitive sensor, an optical sensor or an infra-red sensor.

25. The apparatus according to claim 1, wherein the high lift configuration extends lift of the carriage for providing more complete observation of the toast.

26. The apparatus according to claim 1, wherein the carriage is selectively raised to the high lift configuration by holding down a respective button for an extended period.

27. The apparatus according to claim 6, wherein the carriage can be raised to the high lift configuration during a toasting cycle.

28. The apparatus according to claim 1, wherein a user selects a distance between the top of the toaster and a carriage position to predetermine the lowered configuration.

29. The apparatus according to claim 1, wherein height of the carriage in the raised configuration is user selected.

30. The apparatus according to claim 1, wherein height of the carriage in the raised configuration exposes no more than half height of the food item above a respective toasting slot.

31. The apparatus according to claim 1, wherein the lift assembly including a worm gear engaging a threaded shaft that is attached to the carriage, the worm gear causes rotation of the shaft that threadedly engages the carriage, thereby moving the carriage into the raised configuration or the lowered configuration.

32. The apparatus according to claim 1, wherein the lift assembly including a rotatable drive element that is mechanically coupled to a horizontal guide element, such that rotation of the drive element causes the guide element to rise or lower, the guide element being slidably coupled to a central linkage of each of a pair of scissor arms; wherein raising of the guide element causes the arms of the scissor lift to move inward to thereby move the carriage to the high lift configuration, and lowering the guide element causes the arm linkages to move apart, thereby lowering the carriage.

33. The apparatus according to claim 1, the apparatus further including:
a first contact switch operatively associated with the carriage for disabling power to the heating element when in the raised configuration; and
a second contact switch operatively associated with the carriage for indicating when the carriage is in a lowered configuration, the a second contact switch being coupled to the microprocessor for registering that the carriage is in the lowered configuration.

34. The apparatus according to claim 1, wherein the motor is controlled by the microprocessor to raise the carriage to any one of a number of intermediate levels between the lowered configuration and raised positions, such that no more than half of the height of the food item is exposed at the completion of a toasting cycle.

35. The apparatus according to claim 1, the apparatus further including a sensor for determining height if the food item relative to a known location of the carriage.

36. The apparatus according to claim 1, the apparatus further including a user interface for selecting two or more parameter values, wherein the parameter values include time and power.

37. The apparatus according to claim 1, the apparatus further including a display configured to provide visual feedback on various toasting functions, and wherein the display further includes a countdown that changes while a toasting cycle is in progress to indicate the amount of time remaining in the cycle, including any additional time requested by the user.

38. The apparatus according to claim 1, wherein a pre-heat function automatically operates prior to commencement of a toasting cycle.

39. The apparatus according to claim 1, the apparatus having a keep warm mode in which that processor monitors persistence of a toast slice after completion of a toasting cycle, and can operate to commence a keep warm operation in which the carriage is moved to a lowered configuration for maintaining temperature of the toast slice.

40. The apparatus according to claim 1, wherein each toasting element is individually enabled or disabled, and the processor selectively deactivates heating elements when a respective toast cavity is not being utilised.
